(19) United States
(12) Patent Application Publication
(10) Pub. No.: US 2013/0234554 A1
(43) Pub. Date: Sep. 12, 2013

(54) TRANSVERSE FLUX MACHINE APPARATUS

(71) Applicant: Shouichi TANAKA, Nagoya (JP)

(72) Inventor: Shouichi TANAKA, Nagoya (JP)

(21) Appl. No.: 13/451,599

(22) Filed: Apr. 20, 2012

(30) Foreign Application Priority Data
Mar. 6, 2012 (JP) 2012-048906
Apr. 4, 2012 (JP) 2012-090672
Apr. 18, 2012 (JP) 2012-05235

(51) Int. Cl. H02K 21/12

(52) U.S. Cl. 310/156.02

(57) ABSTRACT

An object of the invention is to provide a transverse flux machine apparatus (TFMA) with simple and economical core structure. The TFMA employs a core having laminated iron plates. The core has left diagonal portions and right diagonal portions for forming the 3D flux passages. A plurality of the 3D structures employs laminated iron cores with diagonal portions. By means of employing the diagonal portions, the core looks like a centipede. The centipede-like TFM called CTFM can have a plurality of types. A plurality of motor structure and a plurality of driving means are proposed for the CTFM.

### CROSS-REFERENCE TO RELATED APPLICATIONS

This application claims benefit under 35 U.S.C.119 of JP2012-048906 filed on Mar. 6, 2012, the title of TRANSVERSE FLUX MACHINE APPARATUS, JP2012-090672 filed on Apr. 12, 2012, the title of TRANSVERSE FLUX MACHINE APPARATUS and JP2012-95235 filed on Apr. 19, 2012, the title of TRANSVERSE FLUX MACHINE APPARATUS, the entire content of which is incorporated herein reference.

### BACKGROUND OF INVENTION

1. Field of the Invention

The present invention relates to a transverse flux machine apparatus (TFMA). More particularly, this invention relates to a transverse flux machine apparatus having a core formed with laminated iron plates.

2. Description of the Related Art

A transverse flux machine (TFM) with a large number of poles and short current passages is an attractive electric machine because the machine has a high torque/weight ratio, a high power/weight ratio and a low copper loss. U.S. Pat. No. 7,830,057 proposes a tandem transverse flux machine (TFM) shown in FIG. 1. The TFM is constructed with many core segments. However, the segmented core structure causes to increase magnetic resistance and to decrease robustness.

FIG. 2 shows another prior TFM employing a core made from soft magnetic composites (SMC). However, magnetic characteristic and robustness of the SMC core are not enough. An electric vehicle and a wind turbine wait a direct-drive machine capable of reducing a gear loss and an inertial mass strongly. However, prior TFMs having a permanent magnet rotor is not desirable for a variable-speed machine because of the high electromotive force (EMF) in a high-speed zone and a cost of the permanent magnets. The other proposed TFM such as a TFSRM has smaller values of torque/weight ratio and other problems.

### CITATION LIST

### Patent Literature

PTL 1:U.S. Pat. No. 7,830,057

### SUMMARY OF INVENTION

An object of the invention is to provide a transverse flux machine apparatus (TFMA) having simple core structure employing laminated iron plates. Another object of the invention is to provide a transverse flux machine apparatus having a reduced power loss. Another object of the invention is to provide a transverse flux machine apparatus having an excellent torque characteristic for a variable-speed application.

As for a first aspect of the invention, a transverse flux machine (TFM) has a laminated core made of laminating iron plates with diagonal portions. The diagonal portions for connecting a yoke portion and teeth magnetically are made by means of bending the iron plates. The core has the left teeth, the right teeth, the left diagonal portions, the right diagonal portions and the yoke portion. The centipede-like TFM of the present invention is called CTFM because the core with the diagonal portions seems like a centipede. It is desirable that the diagonal portions extending diagonally extend straightly. It is desirable that an angle between the diagonal portions and the teeth is in a range from 25 degrees to 65 degrees.

However, it is not easy for the TFMs including the CTFM, the centipede-like TFM, to compete with conventional radial flux machines (RFMs) because the RFMs have a long history of the developing. The TFM cannot use the developed results of the RFMs straightly because single-phase rotation method and the core structure of the TFMs are different from popular three-phase RFMs. Accordingly, it is desirable to develop the peculiar motor structure and the peculiar driving converter in order to use features of the TFM fully. Therefore, unique motor structures have been further developed for the TFM as below.

First, a transverse flux induction machine (TFIM) of squirrel cage type is disclosed. The diagonal portions of a rotor of the CTFM, centipede-like TFM, is attracted via rotor teeth by stator teeth to the radial direction of the rotor. Accordingly, it is preferable for the CTFM to employ supporting members supporting at least one of the rotor teeth and the rotor diagonal portions. According to the transverse flux induction machine (TFIM) of the invention, the supporting member is capable of performing as a well-known squirrel-cage secondary conductor with a very low electric resistance because the supporting member made of aluminum or copper surrounds the rotor teeth. Further, the electric-resistance value of the secondary conductor of the TFM becomes low because the TFM has many spaces having the large cross-section and the short length. Thus, a secondary copper loss of the TFIM is reduced largely.

But, it is difficult for the TFIM to generate a starting torque because the TFIM is essentially the single-phase induction machine. The above problem is solved by means of using the double salient structure of the TFIM. In other words, the TFIM of the present invention is started as a single-phase synchronous reluctance motor or a single-phase switched reluctance motor.

According to a preferred embodiment, a first tandem TFIM driven by an internal combustion engine is connected to a second tandem TFIM for driving wheels of a vehicle via a relay. The relay is opened after when generating currents of the first tandem TFIM become nearly equal to motor currents of the second tandem TFIM.

Next, a transverse flux wound rotor machine (TFWRM) for generating a magnet torque of a single-phase synchronous motor is proposed. The TFWRM has a field winding extending in a space between the left teeth and the right teeth. Furthermore, three TFWRMs arranged in tandem have three secondary windings and a three-phase full-bridge diode rectifier fixed to the rotor. The rectifier supplies a field current to the field windings after rectifying the three-phase secondary voltage induced across the three secondary windings. The field winding has a low electric resistance because the field winding has a short length. Thus, a copper loss of the field winding is reduced.

According to a preferred embodiment,each of trapezoid currents or each alternative current with a frequency being different from a fundamental component (a primary component) is supplied to each single-phase winding wound on each stator core. Harmonics of the magnet motive force excited by the stator current induce the secondary alternative voltage across each secondary winding.

According to a preferred embodiment, each primary field winding is wound on each stator core of TFWRMs arranged in tandem. A DC primary field current is supplied to the primary field windings connected in series. Thus, the primary field winding supplies the field current to the field winding of the rotor effectively, when the TFWRM is rotated.

Next, a transverse flux switched reluctance machine (TFSRM) for generating a torque of a single-phase switched reluctance motor is proposed. Further, a transverse flux permanent magnet switched reluctance machine (TFPMSRM) capable of generating a magnet torque and the reluctance torque simultaneously is proposed. The volume of the TFPMSRM is not increased by means of adding the permanent magnet because the TFSRM has the large space. Further,a plurality of the TFMs arranged axially or circumstantially in tandem is proposed. The other features and the other advantages of the invention are explained in embodiments.

### BRIEF DESCRIPTION OF DRAWINGS

FIG. 1 is an axial cross-section showing prior TFMs with segmented cores.

FIG. 2 is a schematic cross-section showing a prior TFM with a SMC core.

FIG. 3 is an axial cross-section showing three TFIMs (transverse flux induction machines) arranged in tandem.

FIG. 4 is an axial cross-section an axially laminated stator core shown in FIG. 3.

FIG. 5 is a partial side view showing the stator core shown in FIG. 4.

FIG. 6 is a partial plan view of the stator core shown in FIG. 4.

FIG. 7 is a circumferential development showing an arrangement of rotor teeth shown in FIG. 3.

FIG. 8 is a circumferential development showing an arrangement of stator teeth shown in FIG. 3.

FIG. 9 is a block circuit configuration showing a TFMA for driving the TFIMs shown in FIGS. 3.

FIG. 10 is a flow chart showing the connection-changing operation of TFMA shown in FIG. 9.

FIG. 11 is a schematic configuration showing an electric power system of series-hybrid vehicle car with two motor-generators employing the TFIMs shown in FIG. 3.

FIG. 12 shows frequencies of a common frequency of the two motor-generators and two rotor frequencies being equivalent to rotor speeds of two motor-generators shown in FIG. 11.

FIG. 13 is a flow-chart showing connection-changing operation of the electric power system shown in FIG. 11.

FIG. 14 is an axial cross-section showing three TFWRMs (transverse flux wound-rotor machines) arranged in tandem.

FIG. 15 is a circuit topology configuration showing an rotor circuit for supplying a field current to field windings of the TFWRM shown in FIG. 14.

FIG. 16 is a circuit topology configuration showing an three-phase inverter for supplying a three-phase stator current to three single-phase windings.

FIG. 17 is a vector view for showing a fundamental current component and a high frequency current component.

FIG. 18 is a figure showing one wave pattern example of a phase current employed by the TFWRM shown in FIG. 14.

FIG. 19 is a flow-chart showing a torque control of the TFWRM shown in FIG. 14.

FIG. 20 is a circumferential development showing arrangement of rotor teeth shown in FIG. 14.

FIG. 21 is a circumferential development showing arrangement of stator teeth shown in FIG. 14.

FIG. 22 is a circumferential development showing a first position of the rotor teeth shown in FIG. 14.

FIG. 23 is a circumferential development showing a second position of the rotor teeth shown in FIG. 14.

FIG. 24 is a circumferential development showing a third position of the rotor teeth shown in FIG. 14.

FIG. 25 is a circumferential development showing a fourth position of the rotor teeth shown in FIG. 14.

FIG. 26 is an axial cross-section showing another TFWRMs arranged in tandem.

FIG. 27 is a circuit topology configuration showing a field current circuit of the TFWRMs shown in FIG. 26.

FIG. 28 is an axial cross-section showing three TFPMs arranged in tandem.

FIG. 29 is a partial development showing the pole areas of a permanent magnet rotor shown in FIG. 28.

FIG. 30 is a partial development showing the stator teeth shown in FIG. 28.

FIG. 31 is a partial development showing a first magnetizing process of the permanent magnet rotor shown in FIG. 28.

FIG. 32 is a partial development showing a second magnetizing process of the permanent magnet rotor shown in FIG. 28.

FIG. 33 is an axial cross-section showing another three TFPM arranged in tandem.

FIG. 34 is a circumferential development showing an arrangement of rotor pole areas shown in FIG. 33.

FIG. 35 is a schematic axial cross-section showing a separated left core, a separated common core and a separated right core of a stator shown in FIG. 33.

FIG. 36 is a circumferential development showing an arrangement of stator teeth shown in FIG. 33.

FIG. 37 is a circumferential development showing an arrangement of yoke portions of stator core shown in FIG. 33.

FIG. 38 is an axial cross-section of another transverse flux permanent magnet machine (TFPM).

FIG. 39 is an axial cross-section of separated stator cores of the TFPM shown in FIG. 38.

FIG. 40 is a schematic view for showing magnetic flux of the TFPM shown in FIG. 38.

FIG. 41 is a side view showing the left core shown in FIG. 38.

FIG. 42 is a side view showing a stator core of the TFPMs shown in FIG. 38.

FIG. 43 is a schematic development showing arrangement of stator teeth shown in FIG. 38.

FIG. 44 is a schematic development showing arrangement of pole-areas of a permanent magnet cylinder shown in FIG. 38.

FIG. 45 is an axial cross-section showing six transverse flux switched reluctance machines (TFSRMs) arranged in tandem.

FIG. 46 is a circumferential development showing an arrangement of stator teeth shown in FIG. 45.

FIG. 47 is a circumferential development showing an arrangement of rotor teeth shown in FIG. 45.

FIG. 48 is an axial cross-section showing six transverse flux permanent magnet switched reluctance machines (TFPMSRMs) arranged in tandem.

FIG. 49 is a circumferential development showing an arrangement of stator teeth shown in FIG. 48.

FIG. 50 is a circumferential development showing an arrangement of rotor teeth shown in FIG. 48.

FIG. 51 is a schematic view showing motions of the rotor of the DC-driven TFPMSRM shown in FIG. 48.

FIG. 52 is a reference view showing motions of the rotor of a AC-driven TFSynRM with same structure as the DC-driven TFSRM shown in FIG. 48.

FIG. 53 is an axial cross-section showing dual-three-phase TFIMs with a circumferential tandem arrangement.

FIG. 54 is a schematic side view showing an arrangement of the TFIMs shown in FIG. 53.

FIG. 55 is an axial cross-section for illustrating separated stator cores and teeth-holders shown in FIG. 53.

FIG. 56 is a partial side view showing a stator core shown in FIG. 53.

FIG. 57 is a developed side view showing the TFM shown in FIG. 53.

FIG. 58 is an axial cross-section showing the stator core shown in FIG. 53.

FIG. 59 is a circumferential development of one arrangement of the stator teeth shown in FIG. 53.

FIG. 60 is a circumferential development of another arrangement of the stator teeth shown in FIG. 53.

FIG. 61 is a schematic side view showing another arrangement of the TFIMs shown in FIG. 53.

FIG. 62 is a circumferential development of rotor teeth shown in FIG. 53.

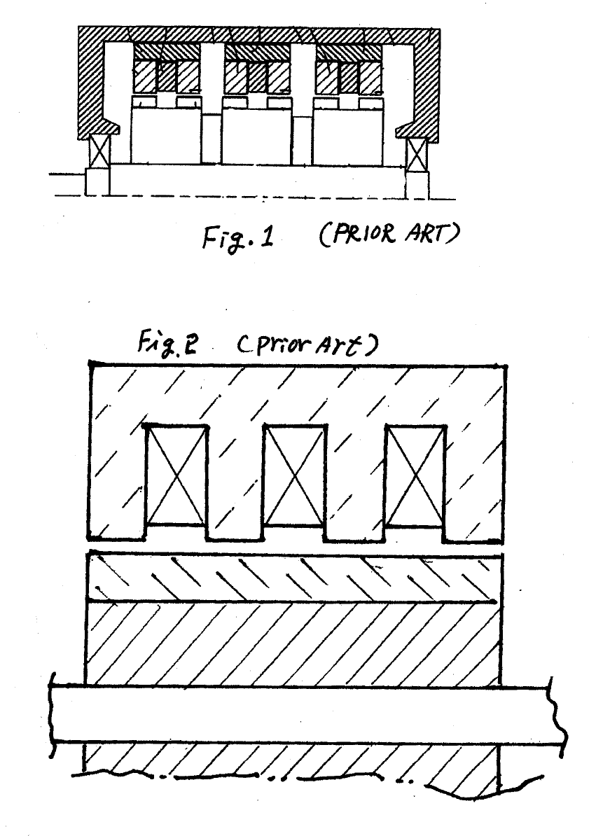

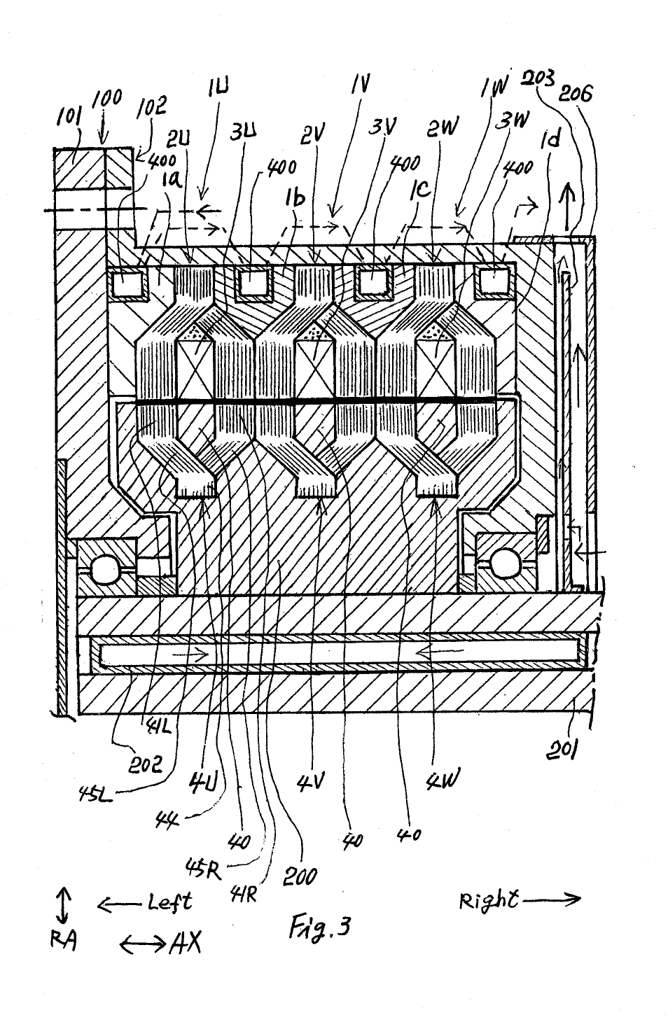

### DETAILED DESCRIPTION OF PREFERRED EMBODIMENTS

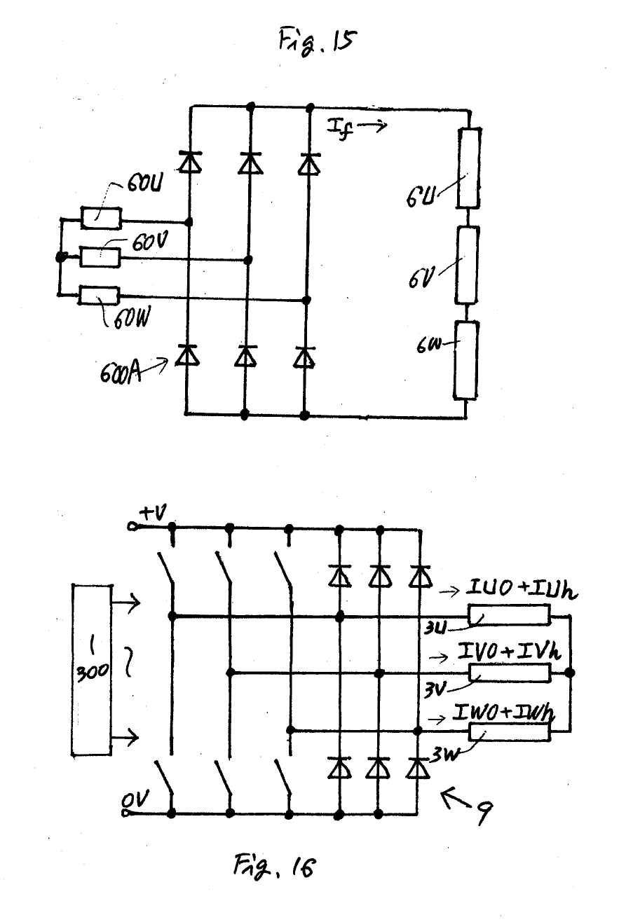

FIGS. 3-62 show five embodiments for showing the centipede-shaped TFMA (called the CTFMA) having the laminated core with diagonal portions for connecting teeth to a core back. FIGS. 3-13 for showing a first embodiment disclose the tandem TFIM technology and the tandem TFSynRM technology having the TFIMs (transverse flux induction machines) or the TFSynRMs (transverse flux synchronous reluctance machines). FIGS. 14-27 for showing a second embodiment disclose the tandem TFWRM technology having three TFWRMs (transverse flux wound rotor machines). FIGS. 28-44 for showing a third embodiment disclose the tandem TFPM technology having three TFPMs (transverse flux permanent magnet machines). FIGS. 45-52 for showing a fourth embodiment disclose the tandem TFSRM technology having six or three TFSRMs (transverse flux switched reluctance machines) or TFPMSRMs (transverse flux switched reluctance machines). FIGS. 53-62 for showing a fifth embodiment disclose the circumferential-tandem TFIM technology having three TFIMs. The circumferential-tandem TFIM means the TFIM with stator cores arranged in tandem to the circumferential direction. The above circumferential-tandem structure can be employed by the other CTFMs. A part of technologies disclosed in the below embodiments are useful for known TFMs with conventional core structure.

### The First Embodiment

The TFMA shown in FIG. 3 has three single-phase TFIMs arranged axially in tandem. A U-phase TFIM has a U-phase stator 1U and a U-phase rotor core 4U. A V-phase TFIM has a V-phase stator 1V and a V-phase rotor core 4V. A W-phase TFIM has a W-phase stator 1W and a W-phase rotor core 4W. The stators 1U, 1V and 1W are fixed to a stator housing 100. U-phase stator 1U has a U-phase stator core 2U accommodating a U-phase winding 3U. V-phase stator 1V has a V-phase stator core 2V accommodating a V-phase winding 3V. W-phase stator 1W has a W-phase stator core 2W accommodating a W-phase winding 3W. The stator cores 2U, 2V and 2W and the phase windings 3U, 3V and 3W have ring shape each.

The stator housing 100 has a disc-shaped front housing 101 and a barrel-shaped rear housing 102. The front housing 101, a teeth-holder 1a, U-phase stator core 2U, a teeth-holder 1b, V-phase stator core 2V, a teeth-holder 1c, W-phase stator core 2W, a teeth-holder 1d and a disc portion of the rear housing 102 are arranged in turn to an axial direction AX of the rotor shaft 201. Detailed structure of teeth-holders 1a-1d, the stator cores 2U, 2V and 2W and the rotor cores 4U, 4V and 4W are explained later.

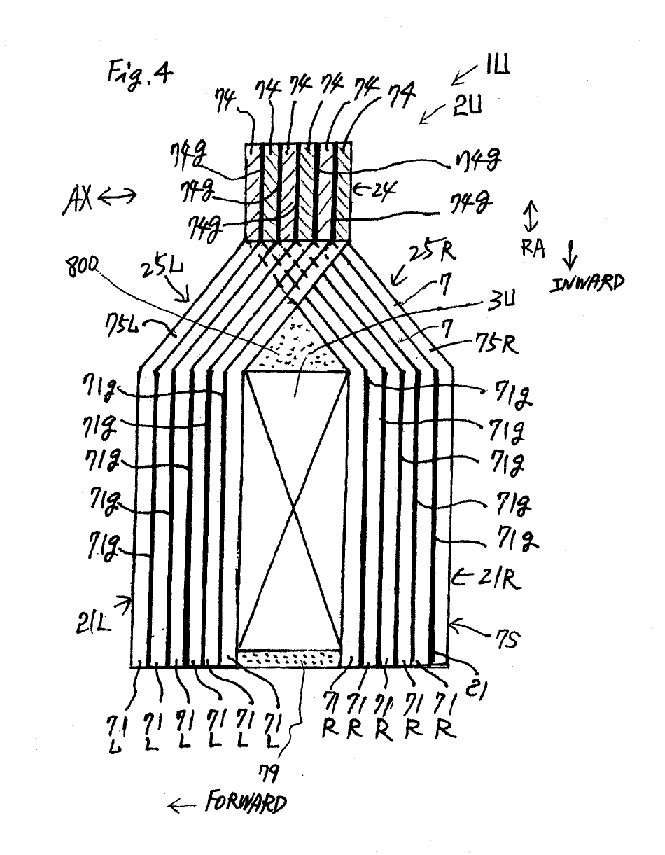

A cooling conduit 400 is wound in each ring-shaped concave portion of teeth-holders 1a-1d. The concave portions extend to the circumferential direction PH along outer circumferential surfaces of teeth-holders 1a-1d made of aluminum. Rear housing 102 accommodates stators 1U-1W, teeth-holders 1a-1d and the cooling conduit 400. Cooling fluid flows through the cooling conduit 400. An inner circumferential surface of a cylinder portion of the rear housing 102 comes into contact with outer circumferential surfaces of stator cores 2U-2W, teeth-holders 1a-1d and the cooling conduit 400. Preferably, teeth-holders 1a-1d come into contact with stator cores 2U-2W across insulation layers (not shown) for reducing eddy currents. The insulation layers are made with same process as resin layers inserted in gaps 71g and 74g between two soft iron plates 7 shown in FIG. 4.

Rotor cores 4U, 4V and 4W arranged axially in tandem are fixed to a rotor housing 200 made with the die-casting method. The rotor housing 200 made of aluminum or copper is fixed to the rotor shaft 201. Stator housing 100 holds the rotor shaft 201 via bearings. Rotor housing 200 constitutes so-called squirrel-cage secondary windings of three single-phase TFIMs. Rotor housing 200 has three ring-shape portions 40 disposed in three ring-shaped slots of rotor cores 4U-4W. Each of rotor cores 4U-4W faces each of stator cores 2U-2W. A rotor shaft 201 has a heat pipe 202 extending axially. A cooling disc 203 made of a copper plate is fixed to rotor shaft 201 at an adjacent position to an outer end surface of rear housing 102. Cooling disc 203 is covered with a resin case 206 having an inlet 204 and an outlet 205. Air boundary layers on the cooling disc 203 remove both disc surfaces of the cooling disc 203 with own centrifugal force, when cooling disc 203 rotates. Generated heat of rotor housing 200 and rotor cores 4U-4W are transferred to cooling disc 203 via rotor shaft 201 with heat pipe 202. Steam or vapor in heat pipe 202 flows to the rear direction. Heat pipe 202 does not need structure for returning condensed liquid because all portions of cylinder-shaped liquid surface in the rotating heat pipe 202 have equal distance from an axial center line of rotor shaft 201. In other words, the heat-transferring capability of the heat pipe is excellent because the condensed liquid returns with own centrifugal force.

U-phase stator 1U with U-phase stator core 2U and U-phase winding 3U is explained referring to FIGS. 4-6. Other stators 1V and 1W are the same as U-phase stator 1U. Each of rotor cores 4U-4W has the same structure as U-phase stator core 2U. Stator core 2U consists of left stator teeth 21L, right stator teeth 21R, a ring-shaped yoke portion 24, left diagonal portions 25L and right diagonal portions 25R. Stator teeth 21L and 21R project inward to the radial direction RA. Ring-shaped yoke portion 24 extends to a circumferential direction PH. Left stator tooth 21L, right stator teeth 21R, left diagonal portions 25L and right diagonal portions 25R are arranged to the circumferential direction PH each.

Each left diagonal portion 25L joins each left stator tooth 21L and yoke portion 24. Each right diagonal portion 25R joins each right stator tooth 21R and yoke portion 24. Left diagonal portions 25L extend diagonally from yoke portion 24 toward the forward direction. Right diagonal portions 25R extend diagonally from yoke portion 24 toward the rear direction. Left stator teeth 21L and right stator teeth 21R are adjacent to each other in the axial direction AX across the ring-shaped U-phase winding 3U accommodated in a ring-shaped slot of U-phase core 2U. Ring-shaped resin spacer 800 with triangle-shaped cross-section is inserted in upper portions of the slot between left stator teeth 21L and right stator teeth 21R.

As shown in FIG. 4, stator core 2U consists of six soft iron plates 7 laminated axially. Each plate 7 consists of left teeth 71L, right teeth 71R, a ring-shaped yoke portion 74, left diagonal portions 75L and right diagonal portions 75R. The left teeth 71L and the right teeth 71R project inward to the radial direction RA. The yoke portion 74 extends to the circumferential direction PH. Each left diagonal portion 75L extending diagonally joins each of left teeth 71L and yoke portion 74. Each of the right diagonal portion 75R extending diagonally joins each of right teeth 71R and yoke portion 74. Therefore, stator core 2U consists of a plurality of axially laminated soft iron plates 7. Similarly, another stator cores 4V and 4W and rotor cores 4U, 4V and 4W consist of a plurality of axially laminated soft iron plates as well as stator core 4U. Left diagonal portions 75L extending straightly to the diagonal direction is formed by means of pressing a flat iron plate. Right diagonal portions 75R formed by means of pressing the flat iron plate extend straightly to the diagonal direction.

A soft iron plate laminated helically can be employed instead of a plurality of soft iron plates 7 stacked axially. It is considered that each ring-shaped gap 74g is formed between each pair of yoke portions 74 being adjacent to each other. Similarly, each teeth-shaped gap 71g is formed between each pair of left teeth 71L being adjacent to each other in the axial direction AX. Similarly, each teeth-shaped gap 71g is formed between each pair of right teeth 71R being adjacent to each other in the axial direction AX. Each of the gaps 74g and 71g are buried with each resin layer including soft iron powder. The resin layer reduces harmonic components of an iron loss. Instead of using the resin layers, yoke portions 74 and teeth 71L and 71R can be curved or bent or projected to the axial direction AX for reducing magnetic vibration. After all, stator core 2U is constructed by means of axially laminating process of a plurality of soft iron plates 7.

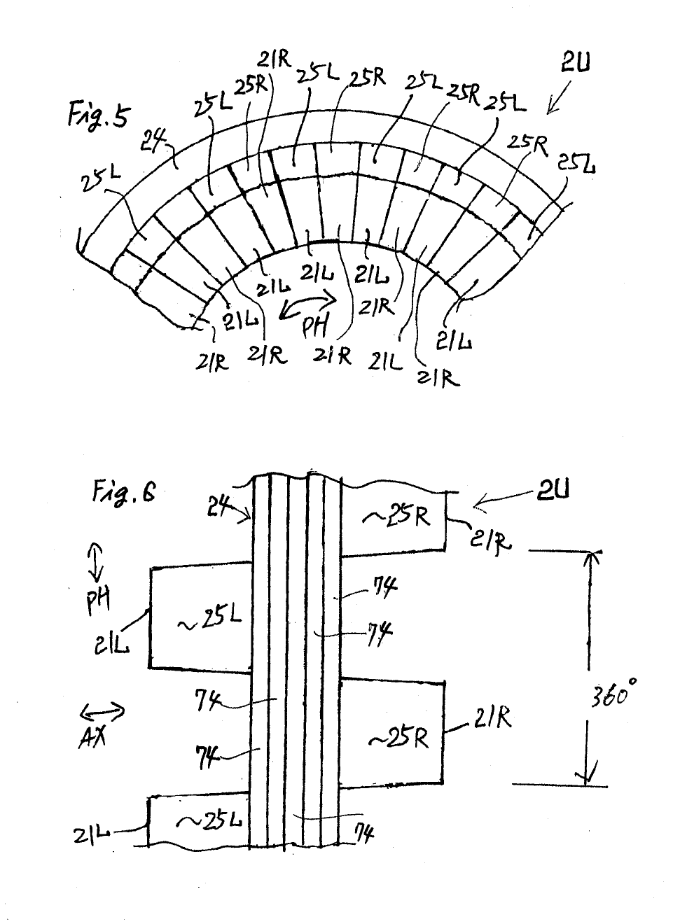

FIG. 5 is a partial side view showing a part of stator core 2U schematically. FIG. 6 is a partial plan view showing a part of stator core 2U schematically. Left stator teeth 21L and right stator teeth 21R are arranged alternately in the circumferential direction PH. Two left stator teeth 21L are adjacent to each other across a space with a circumferential width being mostly equal to one stator tooth 21L. Similarly, two right stator teeth 21R are adjacent to each other across a space with a circumferential width being mostly equal to one stator tooth 21R. Left diagonal portions 25L and right diagonal portions 25R are arranged alternately in the circumferential direction PH. Two left diagonal portions 25L are adjacent to each other across a space with a circumferential width being mostly equal to diagonal portion 25L. Similarly, two right diagonal portions 25R are adjacent to each other across a space with a circumferential width being mostly equal to diagonal portion 25R.

Each of rotor cores 4U-4W consists of left rotor teeth 41L, right rotor teeth 41R, a ring-shaped yoke portion 44, left diagonal portions 45L and right diagonal portions 45R. The left rotor teeth 41L and the right rotor teeth 41R project outward. The yoke portion 44 extends to the circumferential direction PH. Left rotor teeth 41L, right rotor teeth 41R, left diagonal portions 45L and right diagonal portions 45R are arranged to the circumferential direction PH each. Each left diagonal portion 45L joins each left rotor tooth 41L and yoke portion 44. Each right diagonal portion 45R joins each right rotor tooth 41R and yoke portion 44. Left diagonal portions 45L extend diagonally from yoke portion 44 toward the forward direction. Right diagonal portions 45R extend diagonally from yoke portion 44 toward the rear direction. Left rotor teeth 41L and right rotor teeth 41R are adjacent to each other in the axial direction AX across a ring-shaped slot buried with a ring portion 40 of rotor housing 200. The ring portion 40 is a part of a squirrel-cage secondary winding. Left rotor teeth 41L face left stator teeth 21L in the radial direction RA. Right rotor teeth 41R face right stator teeth 21R in the radial direction RA.

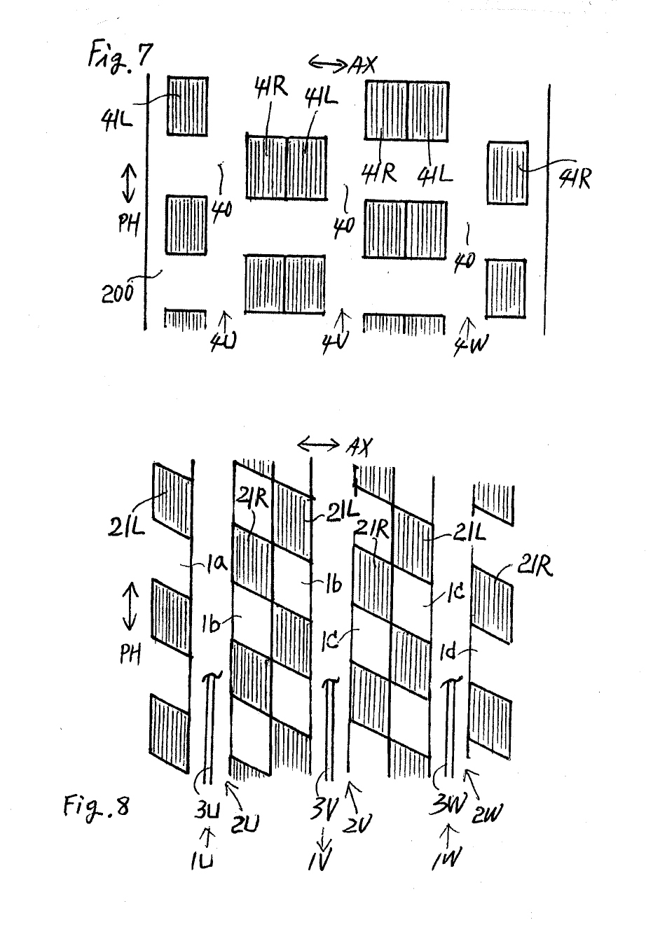

Stator teeth 21L of stator core 2U and rotor teeth 41L of rotor core 4U have a U-phase electric angle. Stator teeth 21L of stator core 2V and rotor teeth 41L of rotor core 4V have a V-phase electric angle. Stator teeth 21L of stator core 2W and rotor teeth 41L of rotor core 4W have a W-phase electric angle. Each angle between each two of the three phase electric angles is 120 degrees. After all, the TFMA shown in FIG. 3 has three transverse flux single-phase induction machines (TFIMs). FIG. 7 is a partial development showing one arrangement of rotor teeth 41L and 41R. FIG. 8 is a partial development showing one arrangement of stator teeth 21L and 21R.

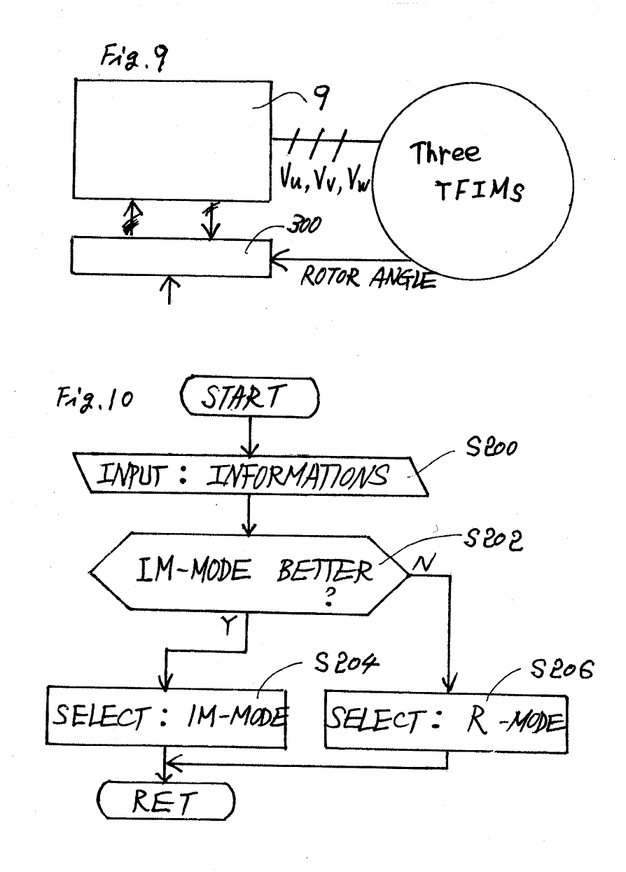

FIG. 9 is a block circuit configuration showing the TFMA with three TFIMs shown in FIG. 3. Three-phase inverter 9 applies a U-phase voltage Vu, a V-phase voltage Vv and a W-phase voltage Vw to three single-phase windings 3U-3W of the three TFIMs respectively. A rotor angle detected from the TFIMs is transmitted to controller 300 having an induction-motor mode and a reluctance-motor mode. The three TFIMs are capable of generating a reluctance torque each because each of the TFIMs has the dual-salient structure. In other words, stator cores 2U-2W are salient type and rotor cores 4U-4W are salient type. Thus, reluctances of three TFIMs are changed in accordance with the rotor angle. On the other hand, each of three TFIMs is not capable of generating the starting torque because the three TFIMs are a single-phase induction motor each. After all, three TFIMs are operated as three single-phase synchronous reluctance motors or three single-phase switched reluctance motors in a starting period.

FIG. 10 is a flow chart showing the selection of either one of the above two modes. First, information including a rotor position, a rotor angular speed and a torque instruction value are detected at the step S200. At next step S202, an induction motor torque Ti and a synchronous reluctance torque Tr are calculated in accordance with the detected information and a memorized map. The induction motor torque Ti is zero, when the speed of the TFIMs is zero. Each TFIM is capable of generating the synchronous reluctance torque Tr, (=(Ld−Lq)IdIq) because each of phase windings 3U-3W has a difference between a d-axis inductance Ld and a q-axis inductance Lq each. The torque Tr is calculated in accordance with the d-axis inductance Ld, the q-axis inductance Lq, a d-axis current Id and a q-axis current Iq.

After the starting of the TFIMs as the synchronous reluctance motors (TFSynRMs) or the switched reluctance motors (TFSRMs), it is judged whether or not an induction-motor mode is better in accordance with efficiency and the torque values at the step S202. The induction-motor mode is selected under conditions that an efficiency of the induction motor operation is higher than an efficiency of the reluctance motor operation. The induction-motor mode is selected at step S204, and the reluctance-motor mode is selected at step S206. According to another case, it is further judged whether or not a rotor temperature is higher than a predetermined threshold value at the step S202. The reluctance-motor mode is selected, when the rotor temperature is higher because the copper loss of the rotor is decreased by means of employing the reluctance-motor mode.

FIG. 11 is a schematic block circuit configuration showing an example of electric power system for driving the above TFIMs employed by series-hybrid vehicle car. The electric power system consists of an engine-side motor-generator (MG1), a wheel-side motor-generator (MG2), an engine-side three-phase inverter 9E, a wheel-side three-phase inverter 9F, and a DC power source 9G and a connection-changing relay 9H. Each of the motor-generators MG1 and MG2 consists of three TFIMs shown in FIG. 3. Three phase windings 3U1, 3V1 and 3W1 of the MG1 are connected to three legs (not shown) of the three-phase inverter 9E respectively. Three phase windings 3U2, 3V2 and 3W2 of the MG2 are connected to three legs (not shown) of the three-phase inverter 9F respectively. A high potential terminal of the DC power source 9G is connected to high potential terminals of inverters 9E and 9F. The connection-changing relay 9H connects three phase windings 3U1, 3V1 and 3W1 and three phase windings 3U2, 3V2 and 3W2 respectively.

Three phase windings 3U1, 3V1 and 3W1 have three phase voltages Vu1, Vv1 and Vw1 respectively. Each phase difference among the three phase voltages Vu1, Vv1 and Vw1 is 120 degrees of electric angle. Three phase windings 3U2, 3V2 and 3W2 have three phase voltages Vu2, Vv2 and Vw2 respectively. Each phase difference among the three phase voltages Vu2, Vv2 and Vw2 is 120 degrees of electric angle. Controller 300 controls frequencies and voltages of six voltages Vu1, Vv1, Vw1, Vu2, Vv2 and Vw2. A common frequency ‘fo’ is selected under conditions that the MG1 is operated as a generator and the MG2 is operated as a motor. Voltages Vu1, Vv1 and Vw1 have a synchronous frequency f1, which is corresponding to the rotor speed of the MG1. Voltages Vu2, Vv2 and Vw2 have a synchronous frequency f2, which is corresponding to the rotor speed of the MG2. Connection-changing relay 9H is turned on, when a difference between two synchronous frequencies f1 and f2 is small. Therefore, U-phase winding 3U1 and 3U2 are connected directly. V-phase winding 3V1 and 3V2 are connected directly. W-phase winding 3W1 and 3W2 are connected directly. A output power of an internal combustion engine connected to the motor-generator MG1 is controlled to keep efficiencies of motor-generators MG1 and MG2 high. After all, the six phase voltages Vu1, Vv1, Vw1, Vu2, Vv2 and Vw2 have a common frequency ‘fo’ each.

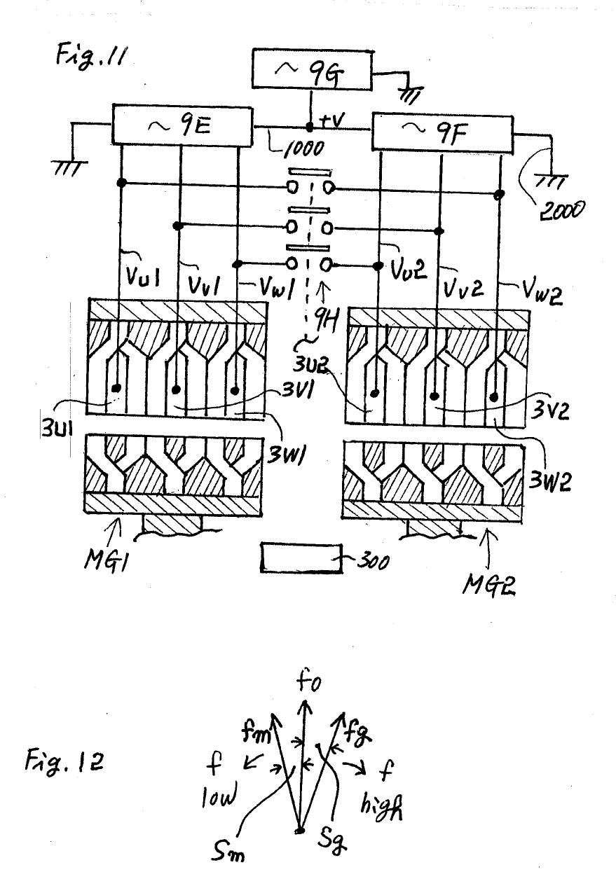

FIG. 12 shows the common frequency ‘fo’, an equivalent synchronous frequency ‘fg’ of the MG1 and an equivalent synchronous frequency ‘fm’ of MG2. The equivalent synchronous frequency ‘fg’ is equivalent to the rotor speed of the MG1. The equivalent synchronous frequency ‘fm’ of MG2 is equivalent to the rotor speed of the MG2. The common frequency ‘fo’ has an intermediate value between the equivalent synchronous frequencies ‘fg’ and ‘fm’. Therefore, the MG1 has a slip rate ‘Sm’, and the MG2 has a slip rate ‘Sg’, when relay 9H are turned on. The common frequency ‘fo’ is controlled in order to realize the current balance between the MG1 and the MG2. Inverters 9E and 9F can be stopped, when the relay 9H is turned on.

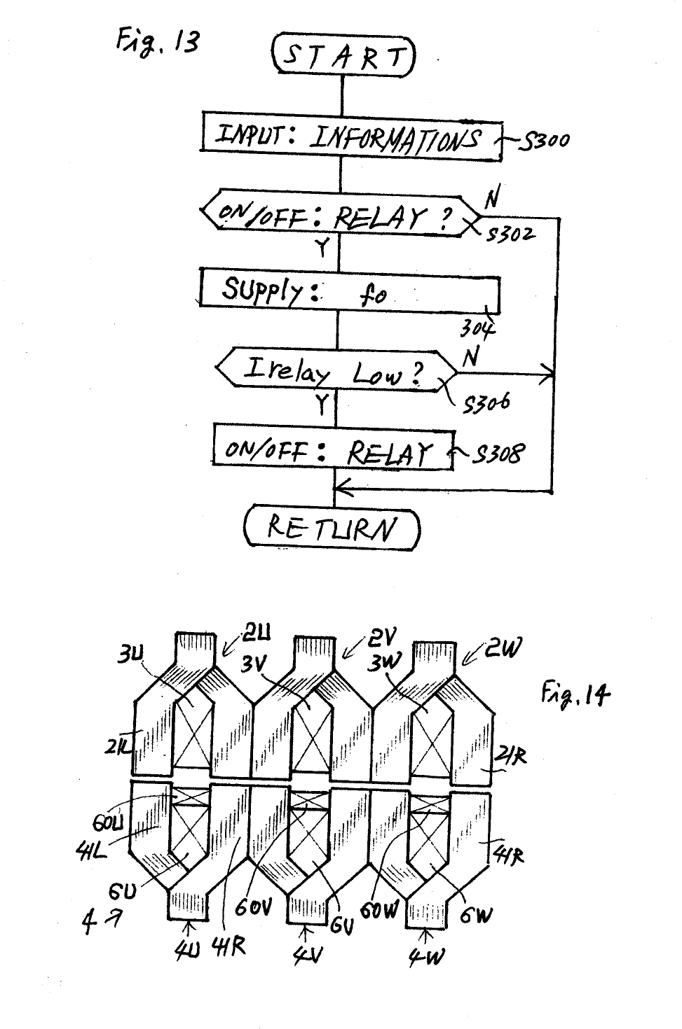

FIG. 13 shows a flow-chart showing one control example of the connection-changing relay 9H. Firstly, information including rotor speeds of MG1 and MG2 are detected at the step S300. At next step S302, it is judged whether or not the connection state of the relay 9H should be changed from the turning-on state to the turning-off state or from the turning-off state to the turning-on state. The relay 9H is turned, when the currents of inverters 9E and 9F have the common frequency ‘fo’. In other words, the inverter 9E and 9F are driven with the common frequency ‘fo’ before the turning-on or the turning-off of relay 9H at the step S304. A current difference between the MG1 and the MG2 is reduced by means controlling the common frequency ‘fo’ and six phase voltages Vu1-Vw2. At next step S306, it is judged whether or not a relay current ‘Irelay’ of relay 9H is lower than a predetermined value. After the relay current ‘Irelay’ becomes smaller than the predetermined value, the state of relay 9H is changed at a step S308. Accordingly, spark of the relay is reduced.

### A First Arranged Embodiment

The first arranged embodiment of the first embodiment is explained. The TFIMs shown in FIG. 3 become an axially tandem transverse flux single-phase synchronous reluctance machines (TFSynRMs) or an axially tandem transverse flux single-phase switched reluctance machines (TFSRMs) by means of abbreviating three ring portions 40 of rotor cores 4U-4W.

### The Second Embodiment

FIG. 14 is an axial cross-section showing the TFMA having three TFWRMs (transverse flux wound-rotor machines) arranged axially in tandem. The three TFWRMs shown in FIG. 14 have field windings 6U, 6V and 6W and secondary windings 60U, 60V and 60W wound on ring-shaped spaces of rotor cores 4U, 4V and 4W. The ring-shaped spaces are formed by means of abbreviating ring portions 40 shown in FIG. 3. The ring-shaped U-phase field windings 6U and the ring-shaped U-phase secondary windings 60U are accommodated in a ring-shaped space between left teeth 41L and right teeth 41R of U-phase rotor core 4U. The ring-shaped V-phase field windings 6V and the ring-shaped V-phase secondary windings 60V are accommodated in a ring-shaped space between left teeth 41L and right teeth 41R of V-phase rotor core 4V. The ring-shaped W-phase field windings 6W and the ring-shaped W-phase secondary windings 60W are accommodated in a ring-shaped space between left teeth 41L and right teeth 41R of W-phase rotor core 4W.

A rotor circuit of the three TFWRMs shown in FIG. 14 is shown in FIG. 15. Secondary windings 60U, 60V and 60W having the star-connection supplies a field current ‘If’ to field windings 6U, 6V and 6W via a three-phase full-wave diode rectifier 600A. Field windings 6U, 6V and 6W are connected in series to each other. Instead of the rectifier 600A shown in FIG. 15, a three-phase half-wave diode rectifier can be employed. Further, each of secondary windings 60U, 60V and 60W performing as the field winding can be short-circuited through each diode. FIG. 16 shows a three-phase inverter 9 connected to three single-phase windings 3U, 3V and 3W wound on three stator cores 2U, 2V and 2W respectively. The inverter 9 can perform as a rectifier, when the TFWRMs work as the three-phase generator.

The inverter 9 supplies a symmetrical three-phase excitation current ‘Ih’ consisting of a U-phase excitation current ‘IUh’, a V-phase excitation current ‘IVh’ and a W-phase excitation current ‘IWh’. Further, the inverter 9 supplies a symmetrical three-phase fundamental stator current ‘I0’ consisting of a U-phase fundamental current ‘IU0’, a V-phase fundamental current ‘IV0’ and a W-phase fundamental current ‘IW0’. Frequencies of fundamental current ‘I0’ and excitation current ‘Ih’ are shown in FIG. 17. In FIG. 16, the currents ‘I0’ and ‘Ih’ has sinusoidal waveforms each. A frequency ‘fh’ of excitation current ‘Ih’ is higher than a frequency ‘f0’ of fundamental current ‘I0’. A slip rate ‘S’ is equal to a value of (fh−f0)/fh. In order to induce each secondary voltage across each of three of secondary windings 60U, 60V and 60W, it is capable of employing spatial harmonics of magnet motive force (MMF) applied to rotor teeth 41L and 41R of rotor 4. In other words, the dual-salient structure of the TFWRM shown in FIG. 14 excites the spatial harmonics of the magnet motive force, even though currents with sinusoidal waveforms are supplied to three single-phase windings 3U, 3V and 3W, because the magnet motive force is modulated spatially. The harmonics of the magnet motive force (MMF) induce an alternative secondary voltage across each of secondary windings 60U, 60V and 60W.

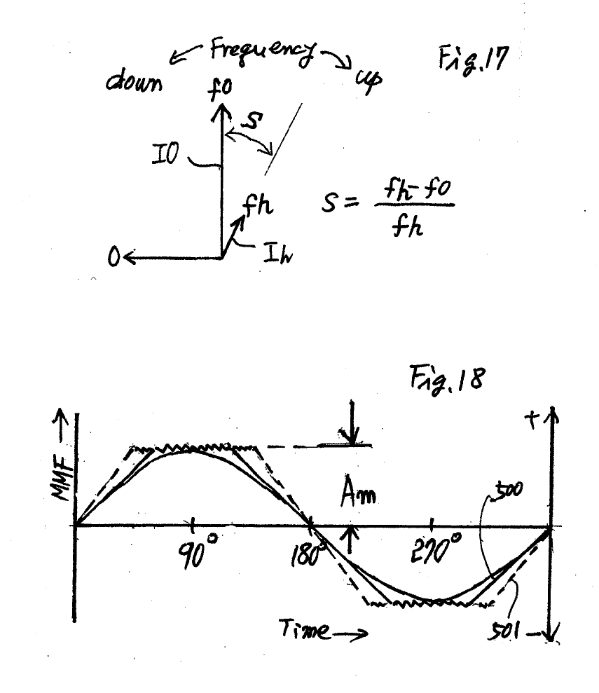

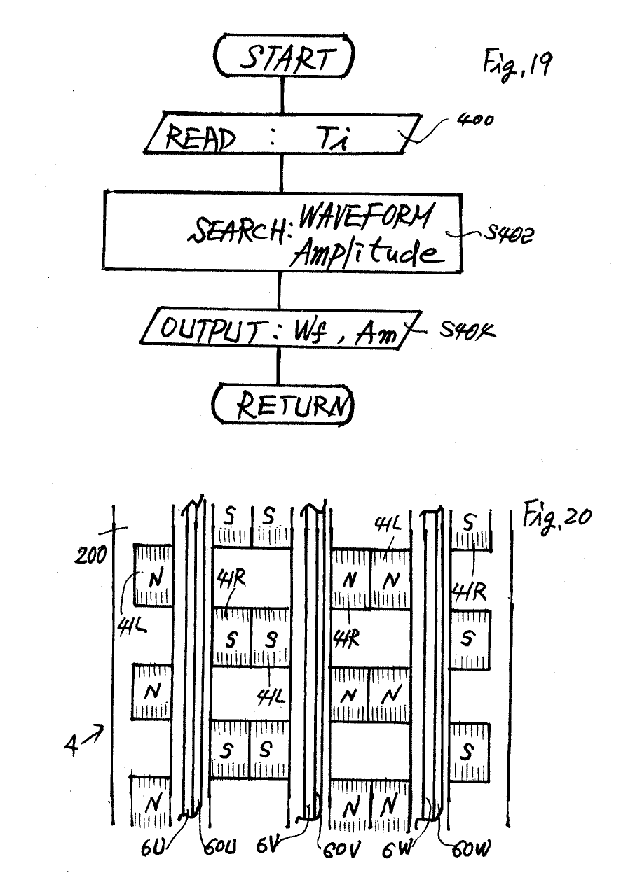

According to another case, each of phase currents supplied to three single-phase windings 3U, 3V and 3W has a trapezoidal waveform each as shown in FIG. 18. The current with trapezoid waveform includes many harmonic components in addition to the fundamental current I0.

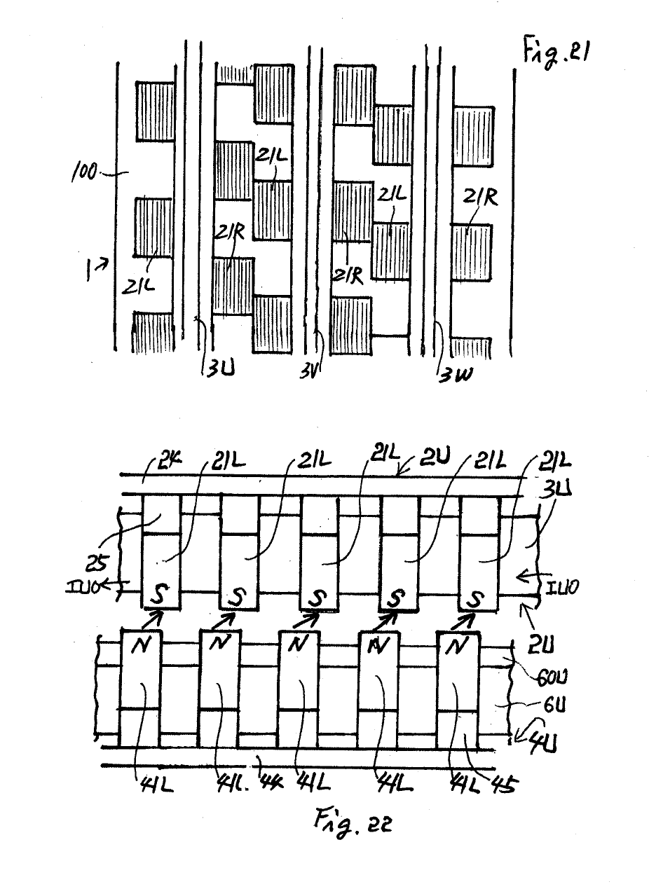

A torque control example of the TFWRM is explained referring to FIG. 19. At a step S400, a torque instruction value ‘Ti’ is read. At next step S402, a waveform and an amplitude of the phase currents with trapezoid waveforms are searched from memorized map. A current-changing rate and an amplitude of the phase currents are increased at a step S404, when the torque instruction value ‘Ti’ is large. The current-changing rate and the amplitude of the phase currents are decreased at the step S404, when the torque instruction value ‘Ti’ is small. Furthermore, the excitation current ‘Ih’ with high frequency is added to the trapezoid phase currents, when the motor speed is low. Because, the frequency of the induced secondary current is decreased, when the motor speed is low. After all, the secondary current is induced by means of the supplying of the fundamental current ‘I0’ with trapezoid waveforms or the supplying of the excitation current ‘Ih’ or the using of the spatial modulation of dual-salient structure of the TFWRM. The inverter 9 supplies the decided fundamental current ‘I0’ and the decided excitation current ‘Ih’.

The secondary windings 60U, 60V and 60W do not require many turns because the field windings 6U, 6V and 6W seem to resistance elements and the frequency of the excitation current Ih is high. Further, a sum of voltages induced across the field windings 6U, 6V and 6W connected in series becomes mostly zero, when the symmetrical three-phase fundamental current I0 is supplied.

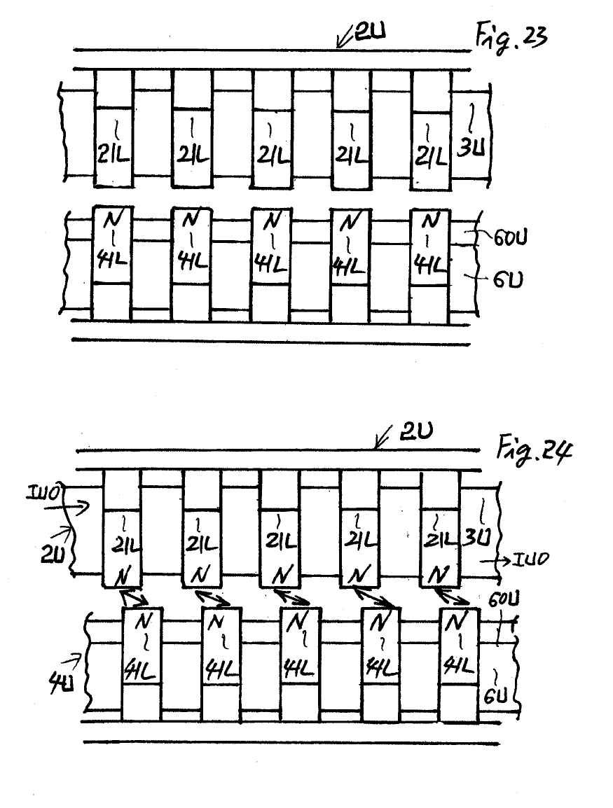

FIG. 20 shows one arrangement of the rotor teeth 41L and 41R. The left teeth 41L of U-phase rotor core 4U, the right teeth 41R of V-phase rotor core 4V and the left teeth 41L of W-phase rotor core 4W is magnetized to N-poles. The right teeth 41R of U-phase rotor core 4U, the left teeth 41L of V-phase rotor core 4V and the right teeth 41R of W-phase rotor core 4W is magnetized to S-poles. FIG. 21 shows one arrangement of the left teeth 21L and the right teeth 21R of stator 1.

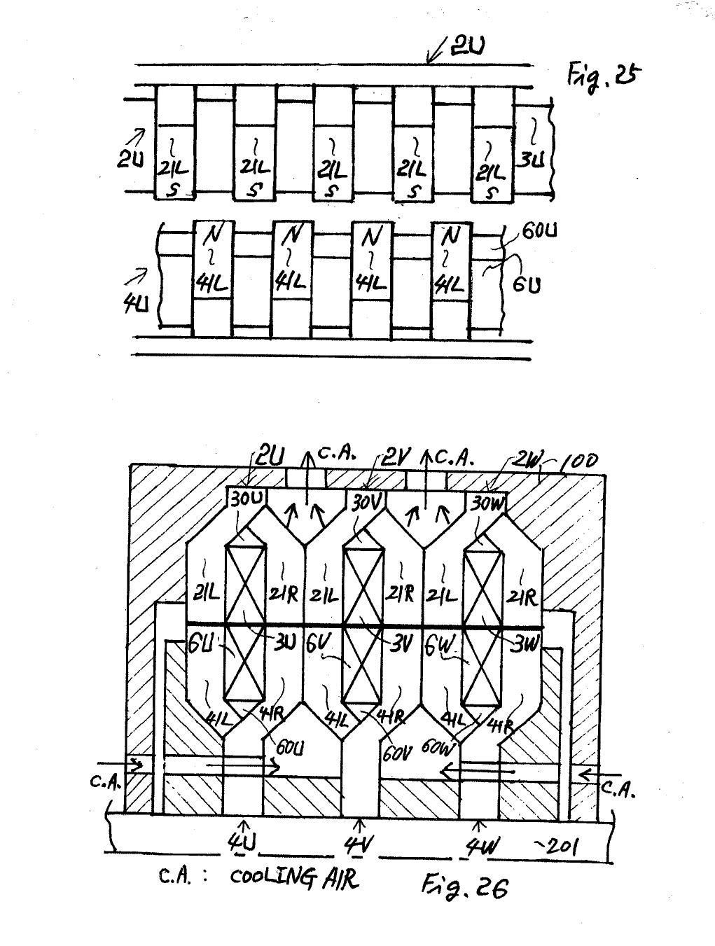

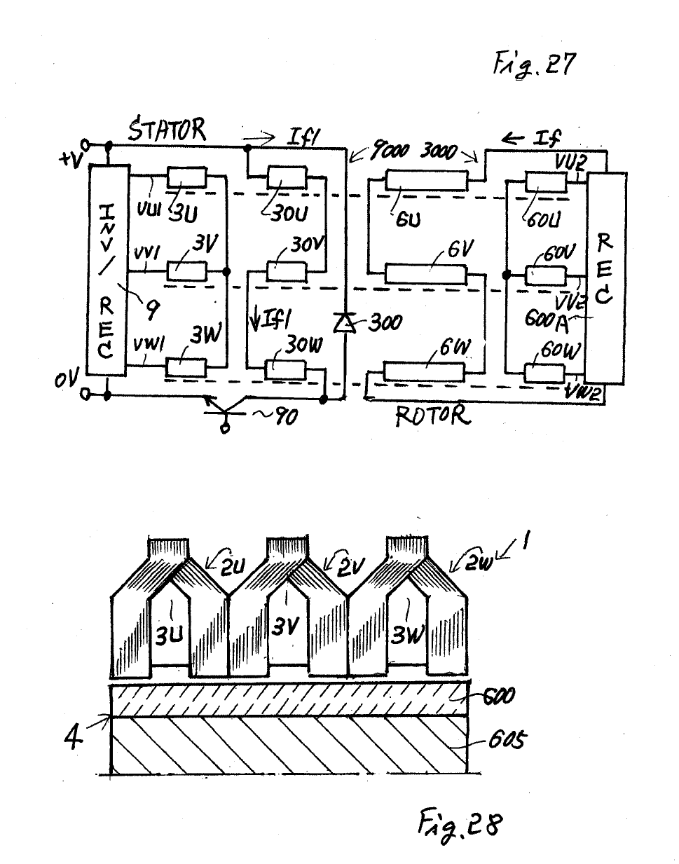

FIGS. 22-25 show circumferential positions of U-phase left teeth 41L of U-phase rotor core 4U. The left teeth 41L is magnetized to N-poles. At a first rotor position shown in FIG. 22, top surfaces of left teeth 21L is magnetized to S-poles. The left teeth 41L is attracted by the left teeth 21L. At a second rotor position shown in FIG. 23, U-phase fundamental current Iu is stopped. At a third rotor position shown in FIG. 24, top surfaces of left teeth 21L is magnetized to N-poles. The repulsion force is given to the left teeth 41L with N-poles. At a fourth rotor position shown in FIG. 25, U-phase fundamental current Iu is stopped.

### A First Arranged Embodiment

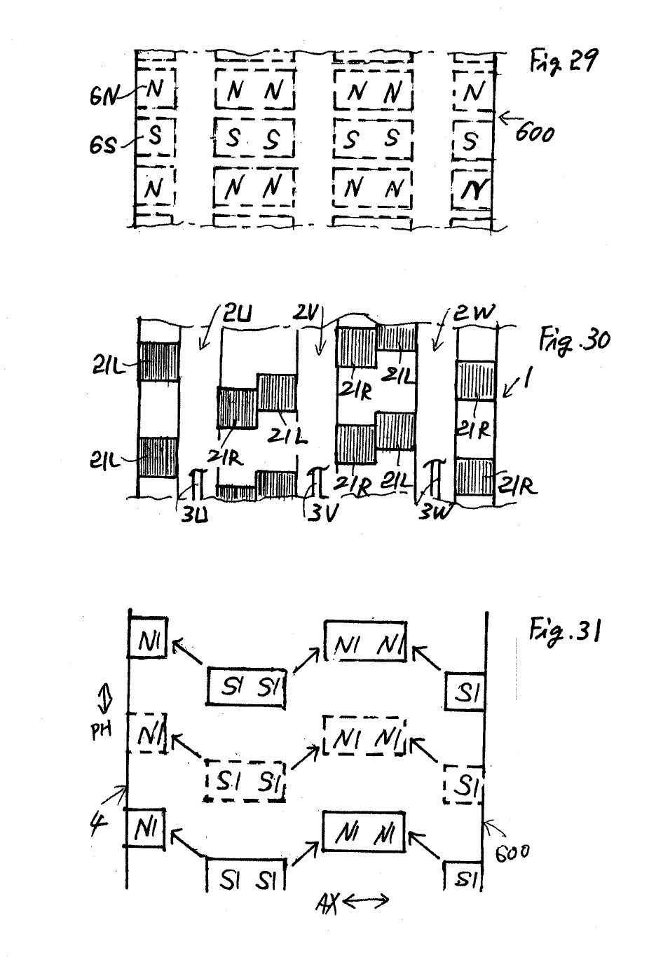

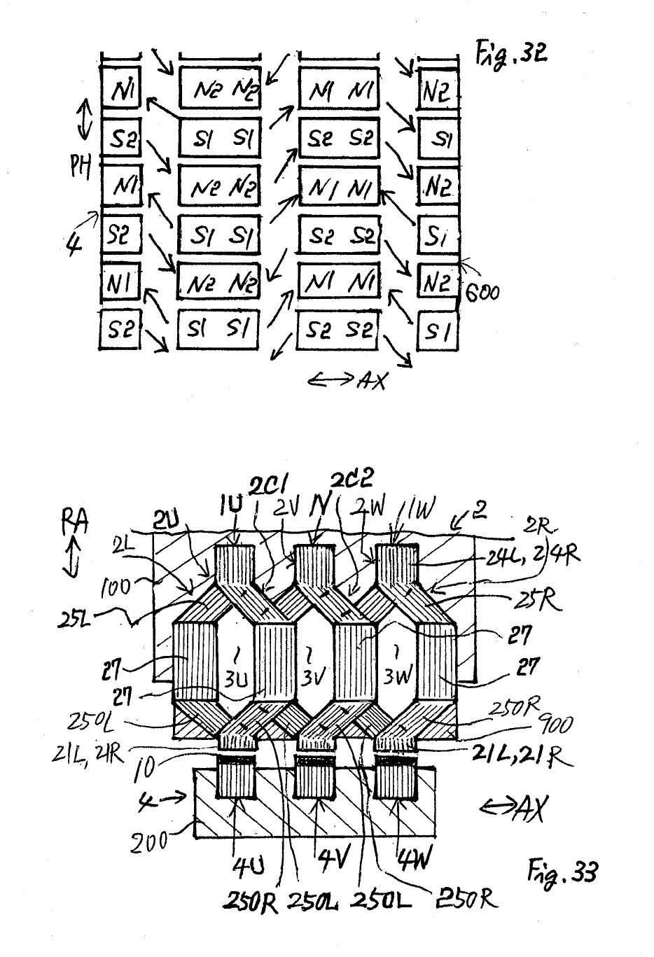

The first arranged embodiment of the TFWRM shown in FIG. 14 is explained referring to FIGS. 26 and 27. FIG. 26 is an axial cross-section showing another TFMA having three TFWRMs arranged axially in tandem. The three TFWRMs shown in FIG. 26 is essentially same as the three TFWRMs shown in FIG. 14 except the addition of primary field windings 30U, 30V and 30W wound in the three ring-shaped slots of stator cores 3U, 3V and 3W respectively. The ring-shaped phase primary field windings 30U is wound on stator core 2U. The ring-shaped V-phase primary field windings 30V is wound on stator core 2V. The ring-shaped W-phase primary field windings 30W is wound on stator core 2W. FIG. 26 further shows the cooling air passages through which the cooling air (C.A.) flows. The cooling air (C.A.) is generated by the rotation of teeth 41L and 41R.

FIG. 27 is a circuit topology configuration showing a stator circuit 9000 and a rotor circuit 3000. The stator circuit 9000 provided at the stator-side has the three-phase inverter 9, a regulation transistor 90 and a freewheeling diode 300. The three-phase inverter 9 is changed to a three-phase full-bridge diode rectifier, when the TFWRM is only driven as the generator. The regulation transistor 90 is PWM-switched in order to control a primary field current If1 flowing through the primary field windings 30U, 30V and 30W connected in series. The freewheeling diode 300 is connected in parallel to primary field windings 30U, 30V and 30W. The rotor circuit 3000 shown in FIG. 27 is the same as the rotor circuit shown in FIG. 15.

Generator operation of the TFWRM shown in FIGS. 26-27 is explained as follows. The primary field current If1 is supplied to primary field windings 30U, 30V and 30W connected in series. Thus, teeth 21L of U-phase stator cores 2U, teeth 21R of V-phase stator core 2V and teeth 21L of W-phase stator core 2W are magnetized to N-poles. Thus, a U-phase voltage VU2, a V-phase voltage VV2 and a W-phase voltage VW2 are induced across three secondary windings 60U, 60V and 60W respectively. Rectifier 600A rectifies the three-phase secondary voltage consisting of the U-phase voltage VU2, the V-phase voltage VV2 and the W-phase voltage VW2, and supplies the rectified field current If to field windings 6U, 6V and 6W. Therefore, teeth 41L and 41R are magnetized. It is desirable that teeth 41L of U-phase rotor cores 4U, teeth 41R of V-phase rotor core 4V and teeth 41L of W-phase rotor core 4W are magnetized to S-poles. In other words, field current If and primary field current If1 flow to the same direction in the circumferential direction PH. Accordingly, three of alternative voltages are induced across three single-phase windings 3U, 3V and 3W respectively. The rectifier 9 rectifies the induced three-phase voltage.

Field windings 6U, 6V and 6W have a larger number of turns than secondary windings 60U, 60V and 60W and primary field windings 30U, 30V and 30W. It is desirable that each of field windings 6U, 6V and 6W has more than five times, more particularly more than ten times of the turns than each of secondary windings 60U, 60V and 60W and each of primary field windings 30U, 30V and 30W. Accordingly, field windings 6U, 6V and 6W with a large inductance storage a large magnetic energy. It means to excite large magnetic flux. Furthermore, the ripple of field current If is reduced. A sum of the inductances of primary field windings 30U, 30V and 30W and a sum of the inductances of field windings 6U, 6V and 6W are almost constant each even though the rotor is rotated. In other words, a sum of overlapping areas (facing areas to each other) of stator teeth 21L and 21R and rotor teeth 41L and 41R of the three TFWRMs are almost constant even though the rotor is rotated. Therefore, a sum of the voltages induced across the primary field windings 30U, 30V and 30W becomes almost zero. Similarly, a sum of the induced voltages of the field windings 6U, 6V and 6W becomes almost zero. It is important that an electric power consumed as a copper loss of field windings 6U-6W is supplied from the mechanical energy of the rotor. Further, the turn number of windings 30U-30W and 60U-60W are reduced because the TFWRM is capable of having a large number of teeth 21L-21R and 41L-41R even though the TFWRM is the unipolar type. According to another arranged embodiment, primary field windings 30U-30W are abbreviated. Instead of the current If1, it is capable to flow a DC primary field current If1 to single-phase windings 3U-3W each.

### A Third Embodiment

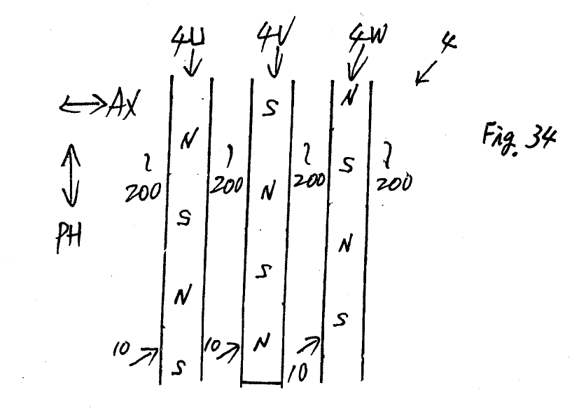

FIG. 28 is a schematic axial cross-section showing the tandem TFMA having three TFPMs arranged axially in tandem. Stator 1 is essentially same as stator 1 shown in FIG. 3. However, the TFPM shown in FIG. 28 does not have a rotor core 4U-4W made of iron plates. The rotor 4 shown in FIG. 28 consists of permanent magnet cylinder 600 fixed to an outer circumferential surface of non-magnetic rotor portion 605 of rotor 4. An outer circumferential surface of the permanent magnet cylinder 600 has N-pole areas 6N and S-pole areas 6S arranged alternately to the circumferential direction as shown in FIG. 29. FIG. 30 shows stator teeth 21L and 21R of stator cores 4U-4W. The rotor 4 is rotated by means of supplying the three-phase currents to three single-phase windings 3U-3W.

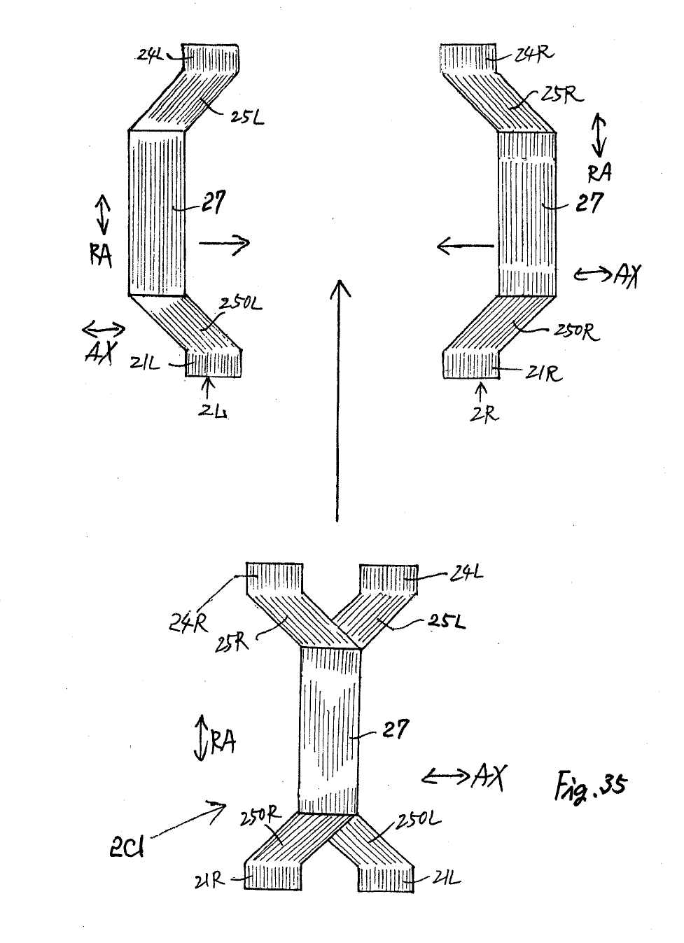

FIGS. 31 and 32 show magnetization process of permanent magnet cylinder 600. At first, N-pole areas N1 of odd numbered lines and S-pole areas Si of even numbered lines are magnetized as shown in FIG. 31. The N-pole areas N1 is formed at different columns from the S-pole areas S1. At next, N-pole areas N2 of odd numbered lines and S-pole areas S2 of even numbered lines are magnetized as shown in FIG. 32. The N-pole areas N2 is formed at different columns from the S-pole areas S2. Therefore, the permanent magnet cylinder 600 is not magnetized to the circumferential direction PH. In other words, circumferential magnetic flux passages from S-pole areas S2 to N-pole areas N1 and circumferential magnetic flux passages from S-pole areas S1 to N-pole areas N2 are made, when all pole areas N1, N2, S1 and S2 are magnetized simultaneously. The above circumferential magnetic flux passages makes saddle-shaped magnetic flux passages in U-phase stator core 2U and U-phase rotor core 4U, when stator teeth 21L face both of adjacent N-pole areas N1 and S-pole areas S2. The above saddle-shaped magnetic flux passages do not cross-link to U-phase winding 3U. It causes to reduce the motor torque largely. It is restrained to make the saddle-shaped magnetic flux passages, when adjacent two pole areas are magnetized in turn.

### A First Arranged Embodiment

FIGS. 33-37 show another TFMA having TFPMs. FIG. 33 is an axial cross-section of three TFPM arranged axially in tandem. The stator cores 2U, 2V and 2W shown in FIG. 33 are essentially same as the stator cores 2U, 2V and 2W shown in FIG. 3. However, the stator cores 2U, 2V and 2W shown in FIG. 33 further have ring portions 27 and lower diagonal portions 250L and 250R. Furthermore, the stator cores 2U, 2V and 2W shown in FIG. 33 have segmented yoke portions 24L and 24R instead of the ring-shaped yoke portion 24 employed in FIG. 3.

According to FIG. 33, three stator cores 2U, 2V and 2W are constructed with a left core 2L, two center cores 2C1 and 2C2 and a right core 2R. The ring-shaped cores 2L, 2C1, 2C2 and 2R are arranged to the axial direction AX in turn. Cores 2L, 2C 1, 2C2 and 2R are made of the axially laminated iron plates respectively. Ring-shaped rotor cores 4U, 4V and 4W are made of the axially laminated iron plates respectively. Rotor cores 4U, 4V and 4W have conventional cylinder shape each. Each of three permanent magnet rings 10 is fixed on each outer circumferential surface of rotor cores 4U, 4V and 4W. It is capable of inserting a predetermined number of permanent magnets into slots of rotor cores 4U, 4V and 4W. The stator core structure shown in FIG. 33 can be employed by the other TFMs except the TFPM, too. FIG. 34 is a circumferential development showing three permanent magnet rings 10. Each permanent magnet ring 10 has N-pole areas N and S-pole areas S arranged alternately in the circumferential direction PH.

FIG. 35 shows construction process of the stator cores 2U, 2V and 2W shown in FIG. 33. One left core 2L, two center cores 2C1 and 2C2 and one right core 2R are provided. However, the center cores 2C2 is not illustrated in FIG. 35 because of limitation of the paper sheet. Left core 2L consists of left yoke portions 24L, upper left diagonal portions 25L, a ring-shaped ring portion 27, lower left diagonal portions 250L and left teeth 21L. The upper left diagonal portions 25L project diagonally and outward from the ring portion 27. Each yoke portion 24L projects outward from each upper left diagonal portion 25L. The lower left diagonal portions 250L project diagonally and inward from ring portion 27. Each left teeth 21L projects from each lower left diagonal portion 250L. The portions 21L, 250L, 25L and 24L are arranged to the circumferential direction PH each. The right core 2R consists of right yoke portions 24R, upper right diagonal portions 25R, a ring-shaped ring portion 27, lower right diagonal portions 250R and right teeth 21R. Each upper right diagonal portion 25R projects diagonally and outward from the ring portion 27. Each of right yoke portions 24R projects outward from each of upper right diagonal portions 25R. The lower right diagonal portions 250R project diagonally from ring portion 27. Each of right teeth 21R projects inward from each of lower right diagonal portions 250R. The portions 21R, 250R, 25R and 24R are arranged to the circumferential direction PH each.

Each of center cores 2C1 and 2C2 consists of the left yoke portions 24L, the right yoke portions 24R, the upper left diagonal portions 25L, the upper right diagonal portions 25R, a ring-shaped ring portion 27, the lower left diagonal portions 250L, the lower right diagonal portions 250R, the left teeth 21L and the right teeth 21R. The diagonal portions 25R and 25L arranged alternately in the circumferential direction PH project diagonally from ring portion 27. Each yoke portion 24R projects outward from each diagonal portion 25R. Each yoke portion 24L projects outward from each diagonal portion 25L. The diagonal portions 250R and 250L arranged alternately in the circumferential direction PH project diagonally from ring portion 27. Each right teeth 21R projects inward from each portion 250R. Each left teeth 21L projects inward from each portion 250L. The portions 21L, 21R, 24L, 24R, 25L, 25R, 250L and 250R are arranged to the circumferential direction PH each.

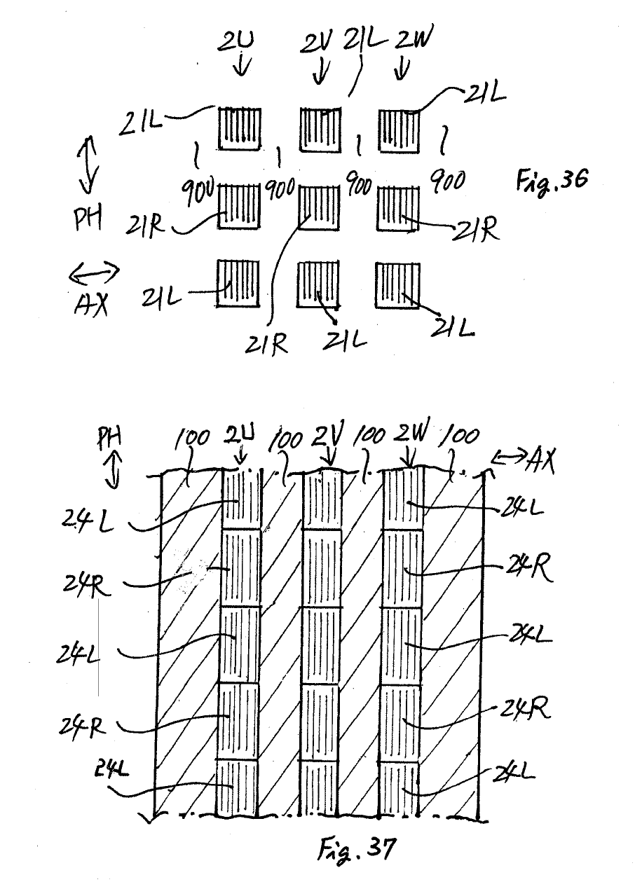

FIG. 36 is a circumferential development of the left teeth 21L and the right teeth 21R. FIG. 37 is a circumferential development of the left yoke portions 24L and the right yoke portions 24R. The left yoke portions 24L and the right yoke portions 24R of each phase are arranged alternately in the circumferential direction PH. Adjacent yoke portions 24L and 24R of each phase come into contact to each other in the circumferential direction PH and constitute the yoke portion 24.

### A Second Arranged Embodiment

FIGS. 38-44 show another TFMA having TFPMs. FIG. 38 is an axial cross-section of three TFPM arranged axially in tandem. The stator cores 2U, 2V and 2W shown in FIG. 38 are essentially same as stator cores 2U, 2V and 2W shown in FIG. 33. Stator cores 2U, 2V and 2W consist of the left stator core 2L, the center cores 2C1 and 2C2 and the right core 2R. However, stator cores 2U, 2V and 2W shown in FIG. 38 do not have the lower diagonal portions 250L and 250R and the teeth 21L and 21R shown in FIG. 33. Stator cores 2L, 2C1, 2C2 and 2R shown in FIG. 38 have teeth 211-214 respectively. The left stator core 2L has the teeth 211 projecting from ring portion 27. The left-center stator core 2C1 has the teeth 212 projecting from ring portion 27. The right-center stator core 2C2 has the teeth 213 projecting from ring portion 27. The right stator core 2R has the teeth 214 projecting from ring portion 27.

FIG. 39 shows stator cores 2L, 2C1, 2C2 and 2R separated to each other. Teeth-shaped yoke portions 24L of left stator core 2L and teeth-shaped yoke portions 24R of left-center stator core 2C1 are arranged alternately to circumferential direction PH. Teeth-shaped yoke portions 24L of left-center stator core 2C1 and teeth-shaped yoke portions 24R of right-center stator core 2C2 are arranged alternately to circumferential direction PH. Teeth-shaped yoke portions 24L of right-center stator core 2C2 and teeth-shaped yoke portions 24R of right stator core 2R are arranged alternately to circumferential direction PH.

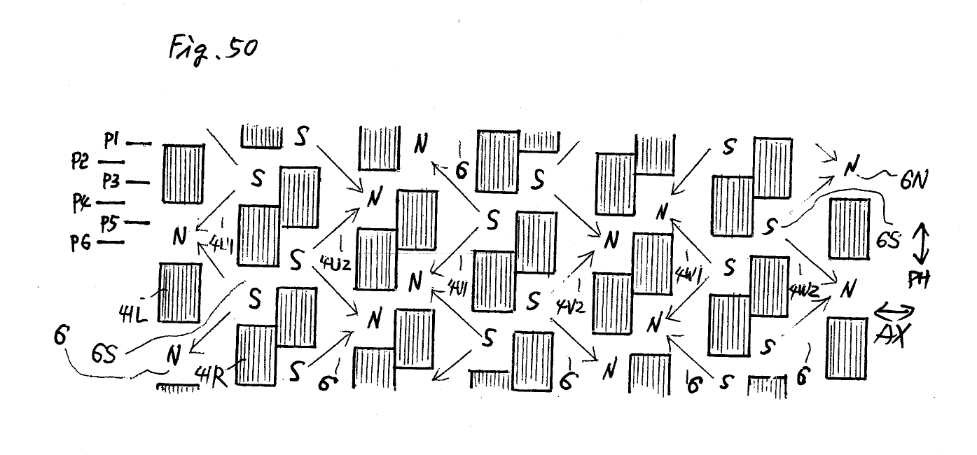

Rotor 4 shown in FIG. 38 has the cylinder-shaped permanent magnet 600 fixed on non-magnetic rotor portion 605. Rotor 4 shown in FIG. 47 is essentially same as rotor 4 shown in FIG. 37 or a rotor of a conventional transverse flux permanent magnet machine (TFPM).

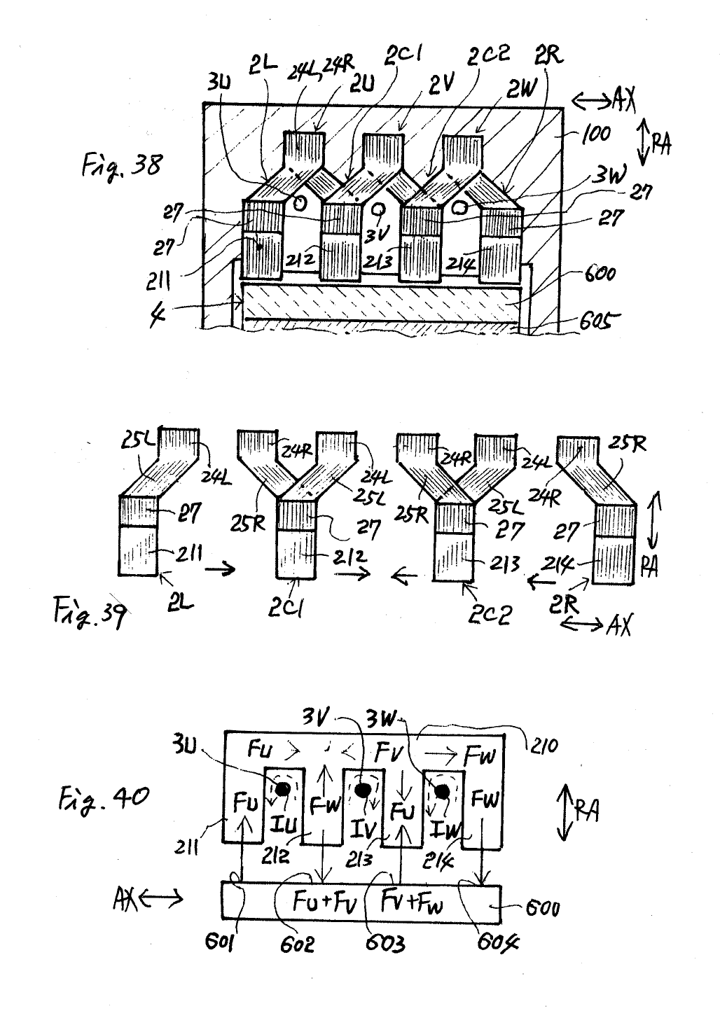

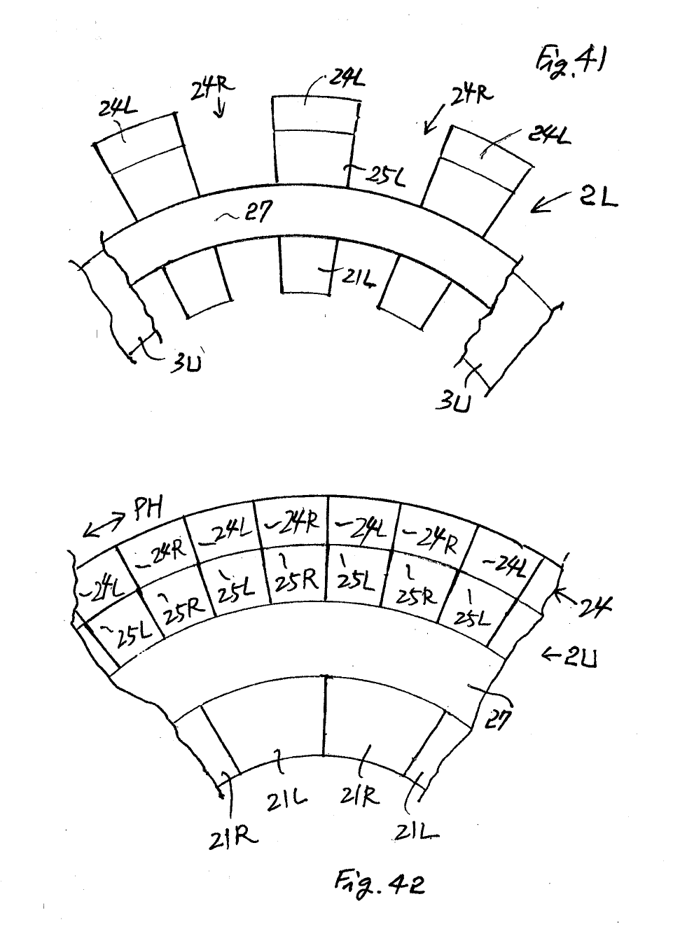

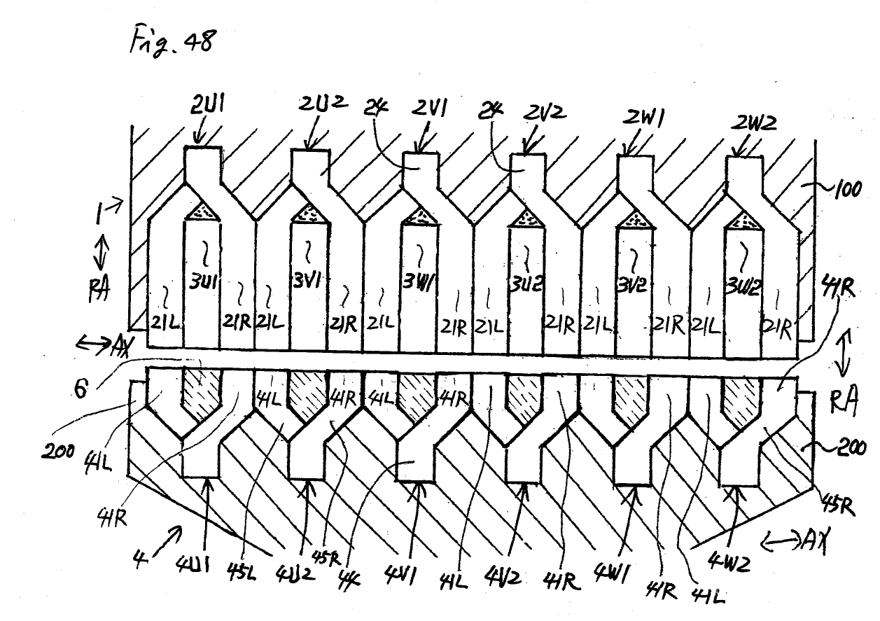

FIG. 40 is a schematic view for showing magnetic flux of the TFPM shown in FIG. 38. Real lines show the magnetic flux of the permanent magnet 600. Dotted lines show the magnetic flux excited by three-phase current Iu, Iv and Iw flowing into three phase windings 3U, 3V and 3W. As shown in FIG. 44, the permanent magnet 600 has columns 601-604 consisting of N-pole areas and S pole-areas. As shown in FIG. 40, the column 601 supplies the magnetic flux Fu to teeth 211. The column 602 supplies the magnetic flux Fw teeth 212. The column 603 supplies the magnetic flux Fv and Fw to teeth 213. The column 604 supplies the magnetic flux Fu and Fv to teeth 214. Each phase differences between each two of the magnetic flux Fu, Fv and Fw is 120 electric degrees. In other words, the permanent magnet flux Fu, Fv and Fw penetrating into teeth 211-214 are modulated spatially by means of rotating the rotor 4.

The U-phase permanent magnet flux Fu cross-linked to U-phase winding 3U has mostly the sinusoidal waveform, when rotor 4 rotates. Similarly,the V-phase permanent magnet flux Fv cross-linked to V-phase winding 3V has mostly the sinusoidal waveform. Similarly,the W-phase permanent magnet flux Fw cross-linked to W-phase winding 3W has mostly the sinusoidal waveform. Thus, the TFPM generates three-phase motor torque with three-phase sinusoidal waveform or three-phase generation voltage with three-phase sinusoidal waveform.

FIG. 41 is a partial side view of the left core 2L. FIG. 42 is a partial side view of the U-phase stator core consisting of the left core 2L and the left-center stator core 2C1. Left core 2L has left teeth 21L, a ring portion 27, left diagonal portions 25L and left yoke portions 24L. Left yoke portions 24L and right yoke portions 24R are arranged alternately in the circumferential direction PH and come into contact to each other. Yoke portions 24L and 24R constitute a ring-shaped yoke portion 24 shown in FIG. 3. Vibration of stator teeth 21L and 21R are decreased because stator teeth 21L and 21R project from ring portions 27. Stator cores 2V and 2W have same structure as stator core 2U.

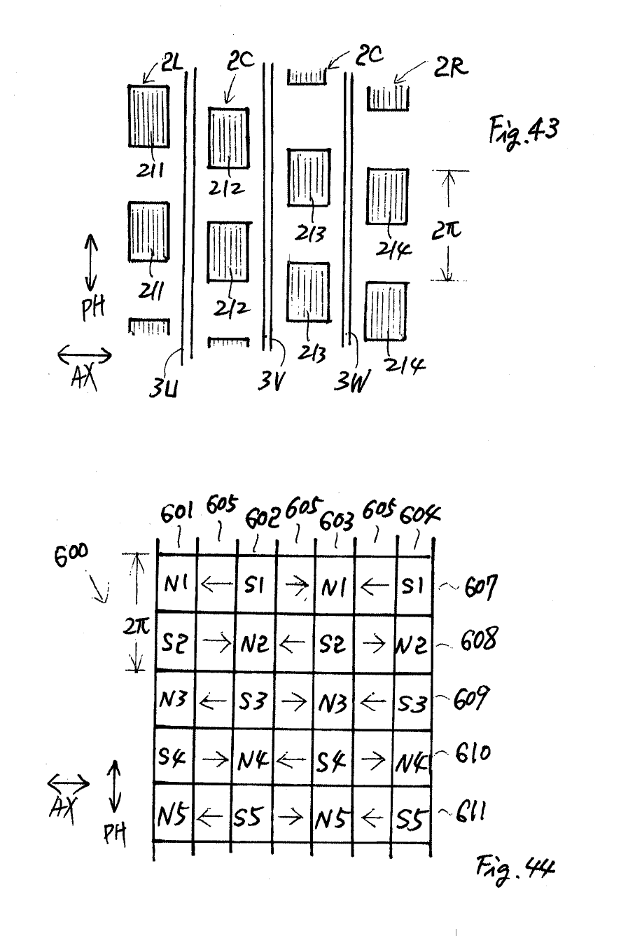

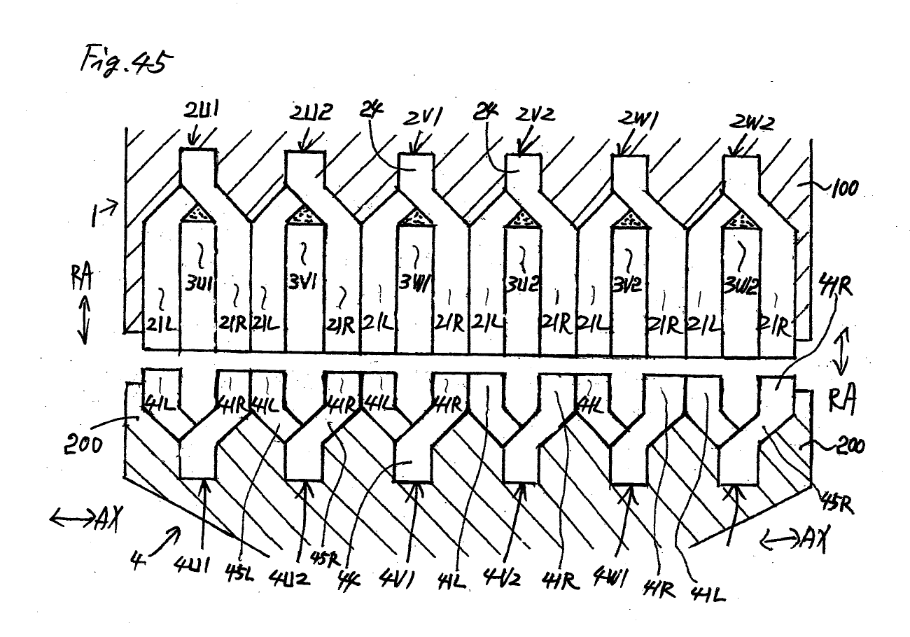

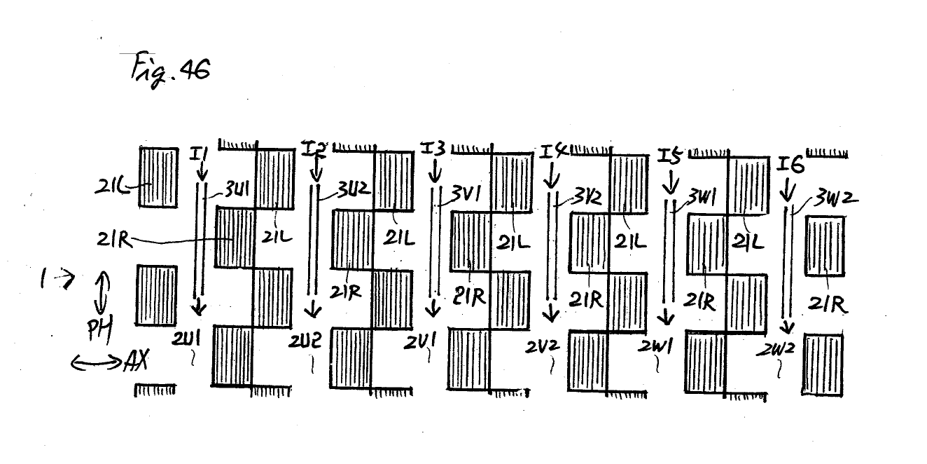

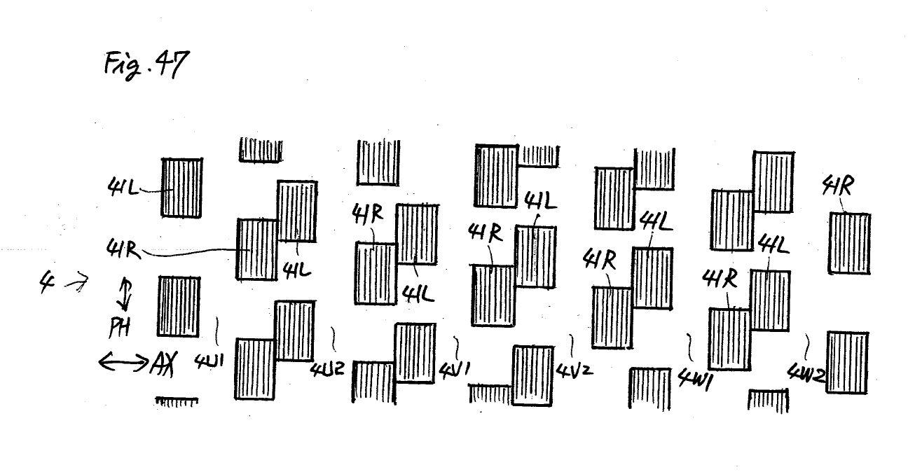

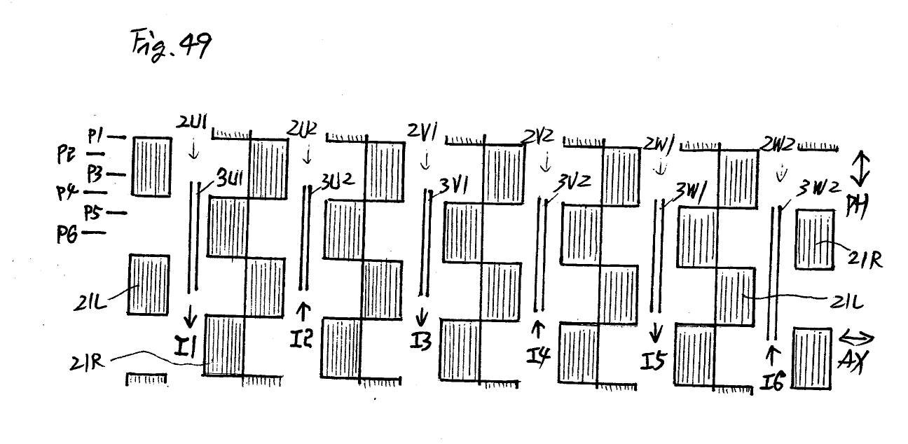

FIG. 43 is a schematic development showing the arrangement of stator teeth 211-214. The arrangement of stator teeth 211-214 is different from arrangement of stator teeth 21L and 21R shown in FIG. 46. It is important that the circumferential positions of teeth 211-214 are free even though the cores 2L, 2C1, 2C2 and 2R are overlapped in the axial direction AX.

FIG. 44 is a schematic circumferential development showing arrangement of pole areas N1-N5 and S1-S5 of permanent magnet cylinder 600. FIG. 44 shows four columns 601-604 of pole areas N1-N5 and S1-S5 of permanent magnet cylinder 600. FIG. 44 shows five lines 607-611 including the N-pole areas N1-N5 and the S-pole areas S1-S5. Each of N-pole areas N1-N5 and each of S-pole areas S1-S5 are arranged alternately in the circumferential direction PH. Each of magnetized intermediate columns 605 is disposed between adjacent two of the columns 601-604 in order to form the magnetic flux passages in permanent magnet cylinder 600. The intermediate column 605 is magnetized to axial direction AX. However, permanent magnet cylinder 600 in not magnetized to the circumferential direction PH. The even numbered columns 608 and 610 are magnetized after when the odd numbered columns 607, 609 and 611 have been magnetized in order to cancel the magnetic flux passages extending to the circumferential direction PH.

### A Fourth Embodiment

The fourth embodiment is explained referring to FIGS. 45-52. FIGS. 45-52 disclose a TFMA having six single-phase transverse flux switched reluctance machines (TFSRMs) or six single-phase transverse flux permanent magnet switched reluctance machine (TFPMSRMs). FIG. 45 is an axial cross-section showing six single-phase TFSRMs arranged axially in tandem. FIG. 46 is a circumferential development showing stator teeth 21L and 21R of stator 1.

Stator 1 has a Ul-phase stator core 2U1, a U2-phase stator core 2U2, a V1-phase stator core 2V1, a V2-phase stator core 2V2, a W1-phase stator core 2W1 and and a W2-phase stator core 2W2. The stator cores 2U1-2W2 have six phase windings 3U1, 3U2, 3V1, 3V2, 3W1 and 3W2 respectively. Each line with each arrow shown in FIG. 46 shows each current direction of six phase currents I1-I6 flowing through the phase windings 3U1-3W2 respectively. FIG. 47 is a circumferential development showing an arrangement of rotor teeth 41L and 41R of six rotor cores 4U1, 4U2, 4V1, 4V2 4W1 and 4W2 of rotor 4. Stator 1 and rotor 4 shown in FIG. 45 is equal to stator 1 and rotor 4 shown in FIG. 3. However, rotor 4 shown in FIG. 45 does not have ring portion 40 shown in FIG. 3. In FIG. 46, stator teeth 21L of each phase are arranged at an equal circumferential position. In FIG. 47, adjacent two rotor cores have a spatial difference, which is equivalent to 60 electric angular degrees, in the circumferential direction.

### A First Arranged Embodiment

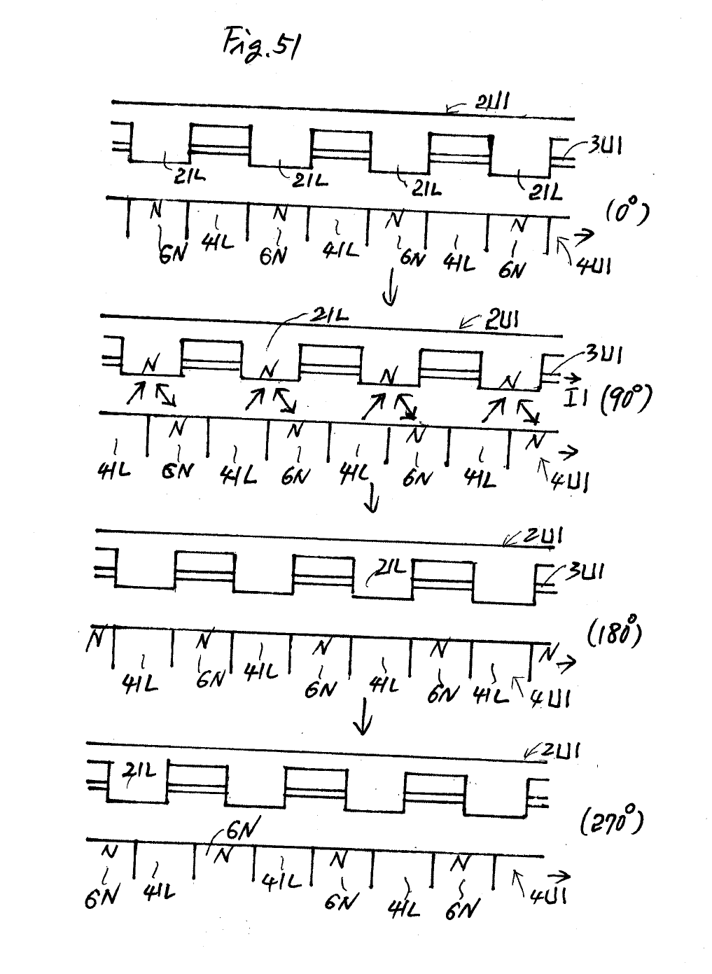

The first arranged embodiment of the fourth embodiment is explained referring to FIGS. 48-52. FIGS. 48-50 show six transverse flux permanent magnet switched reluctance machines (called TFPMSRMs) arranged axially in tandem. FIG. 48 is an axial cross-section showing the six-phase TFPMSRM. The TFPMSRMs shown in FIGS. 48-50 are essentially same as the TFSRMs shown in FIGS. 45-47 except a permanent magnet layer 6 shown in FIG. 48. The permanent magnet layer 6 is disposed in spaces among teeth 41L and 41R of six rotor cores 4U1-4W2 arranged axially in tandem. Permanent magnet layer 6 is made from ferrite magnet material covering outer circumferential surfaces of rotor cores 4U1-4W2 except top surfaces of the teeth 41L and 41R. FIG. 49 is a circumferential development showing an arrangement of stator teeth 21L and 21R shown in FIG. 48. FIG. 50 is a circumferential development showing an arrangement of rotor teeth 41L and 41R of rotor cores 4U1-4W2 and S-pole areas 6S and N-pole areas 6N of permanent magnet layer 6. N-pole areas 6N are disposed between each two left rotor teeth 41L of rotor cores 4U1, 4V1 and 4W1 and between each two right rotor teeth 41R of rotor cores 4U2, 4V2 and 4W2 in the circumferential direction PH. S-pole areas 6S are disposed between each two right rotor teeth 41R of rotor cores 4U1, 4V1 and 4W1 and between each two left rotor teeth 41L of rotor cores 4U2, 4V2 and 4W2 in the circumferential direction PH. Phase currents 12, 14 and 16 flows to the opposite direction to phase currents I1, I3 and I5 as shown in FIG. 49.

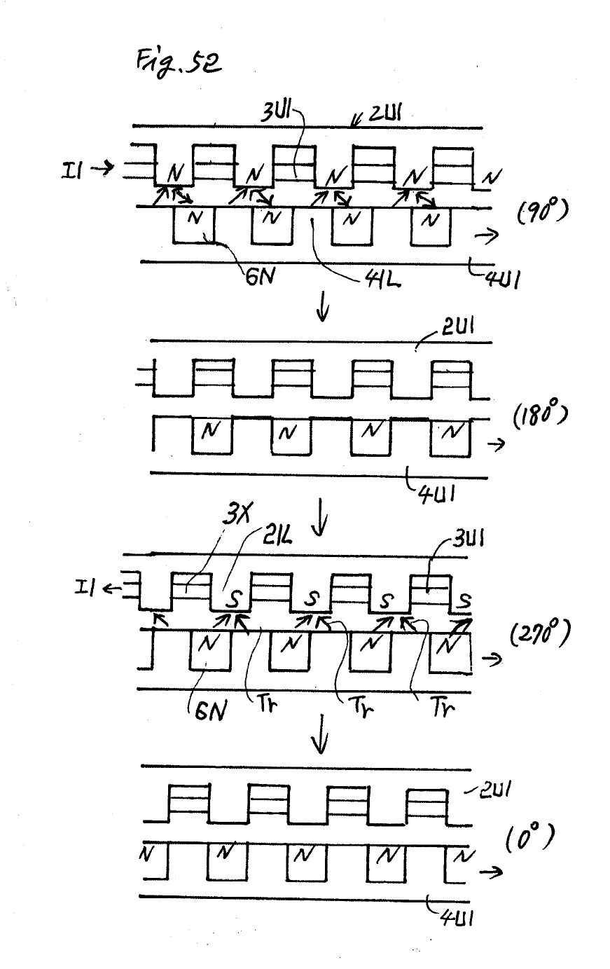

Each TFPMSRM shown in FIG. 48 generates both of the switched reluctance torque and the permanent magnet torque simultaneously. FIG. 51 is a schematic side view for showing four positions of left teeth 41L of rotor core 4U1 moving to the right direction. At zero electric degree, left rotor teeth 41L are at positions between each two left stator teeth 21L. Each N-pole area 6N just faces left teeth 21L. At 90 electric degrees, the Ul-phase current I1 is supplied to Ul-phase winding 3U1. Teeth 21L attract the left teeth 41L and repulse N-pole areas 6N because top surfaces of the left teeth 41L are magnetized to N-poles. At 180 electric degrees, the left rotor teeth 41L face the next left teeth 21L. Then, U1-phase current I1 is stopped. The other rotor cores 4U2-2W2 move rotor core 4U1 to the right direction. The left teeth 41L reach at a position of zero electric degree. A total torque of the TFPMSRM is increased because the TFPMSRM produces both of the attracting torque of the rotor teeth 41L, which is the switched reluctance motor torque, and the repulsion magnet torque of N-pole areas 6N, which is the permanent magnet torque, during the period from zero electric degrees to 180 electric degrees in the motor operation.

It is important that a copper loss and an iron loss of the TFPMSRM are reduced relatively because the permanent magnet torque is generated without extending the current-supplying period. Furthermore, the TFPMSRM does not need to increase the sizes because the permanent magnet layer 6 is disposed in the space among the rotor teeth 41L, 41R.

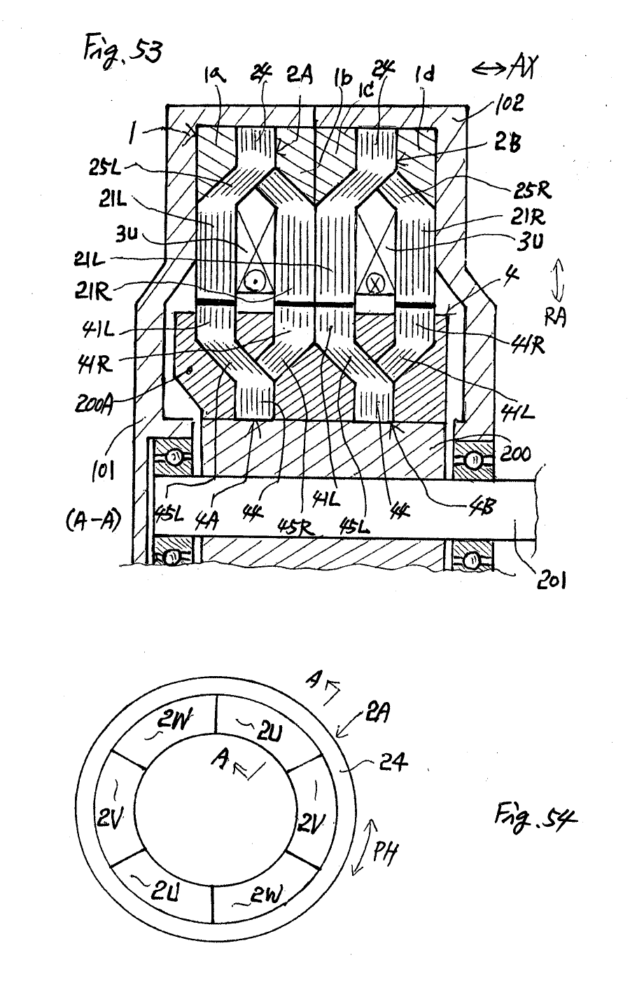

FIG. 52 is a reference side view for showing a motor-operation of an AC-driven TFPMSRM or AC-driven TFSynRM with a permanent magnet layer 6. The stator and the rotor shown in FIG. 52 are same as the stator and the rotor shown in FIG. 51. FIG. 52 shows four positions of left rotor teeth 41L of rotor core 4U1 moving to the right direction. The torque pattern of the left teeth 41L shown in FIG. 52 is the same as the torque pattern of the left teeth 41L shown in FIG. 51 in a period from 0 electric degrees to 180 electric degrees. However, the torque of the left teeth 41L shown in FIG. 52 is different from the torque of the left teeth 41L shown in FIG. 51 in a period from 180 electric degrees to zero electric degree. For example, at 270 electric degrees, the left stator teeth 21L shown in FIG. 52 become S-pole, because the AC phase current I1 flows to the reverse direction. Thus, left stator teeth 21L attract both of N-pole areas 6N and the left rotor teeth 41L. The attracting torque Tr of the left rotor teeth 41L is the braking torque. After all, the ratio of torque / current is not increased much, when the large AC current is supplied, but the copper loss and the iron loss are increased because the current-supplying period is extended. Moreover, the AC-driving method needs an inverter, which needs more switching elements in comparison with a DC-driven asymmetrical power converter.

### The Fifth Embodiment

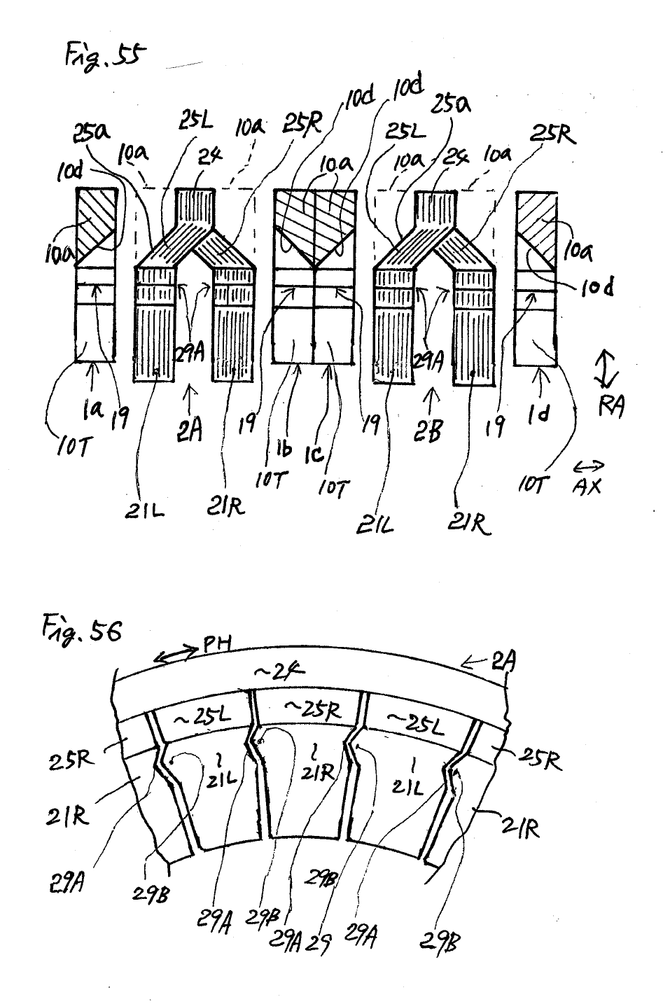

The fifth embodiment for disclosing the CTFM with the circumferential tandem structure is explained referring to FIGS. 53-54. FIG. 53 is an axial cross-section showing a three-phase TFIM with circumferential tandem structure. FIG. 54 shows a schematic side view of the three-phase TFIM shown in FIG. 53. Two sets of three stator cores 2U, 2V and 2W are arranged to the circumferential direction in turn. Each of the six stator cores has essentially arc-shape of 60 degrees each.

In FIG. 53, stator 1 has stator cores 2A and 2B arranged axially in tandem. Two arc-shaped portions of one U-phase winding 3U are accommodated in arc-shaped slots of stator cores 2A and 2B respectively. Stator housing 100 having a bowl-shaped front housing 101 and a bowl-shaped rear housing 102 accommodates teeth-holder 1a, stator core 2A, teeth-holder 1b and 1c, stator core 2B and teeth-holder 1d in turn in the axial direction. Rotor 4 has ring-shaped rotor cores 4A and 4B arranged axially in tandem. Copper cylinder 200A constituting the squirrel-cage secondary winding is fixed on rotor housing 200 fixed to rotor shaft 201.

As shown in FIG. 54, the two sets of arc-shaped stator cores 2U, 2V and 2W are arranged to the circumferential direction PH in turn. However, two sets of stator cores 2U, 2V and 2W have a ring-shaped common yoke portion 24. In other words, stator teeth 21L and 21R and diagonal portions 25L and 25R of stator core 2A belong to the two sets of stator cores 2U, 2V and 2W. Similarly, stator teeth 21L and 21R and diagonal portions 25L and 25R of stator core 2B belong to the two sets of stator core portions 2U, 2V and 2W. Each of arc-shaped phase windings 3U, 3V and 3W has mostly 60 degrees. U-phase winding 3U is wound on adjacent two stator core portions 2U. V-phase winding 3V is wound on adjacent two stator core portions 2V. W-phase winding 3W is wound on adjacent two stator core portions 2W.

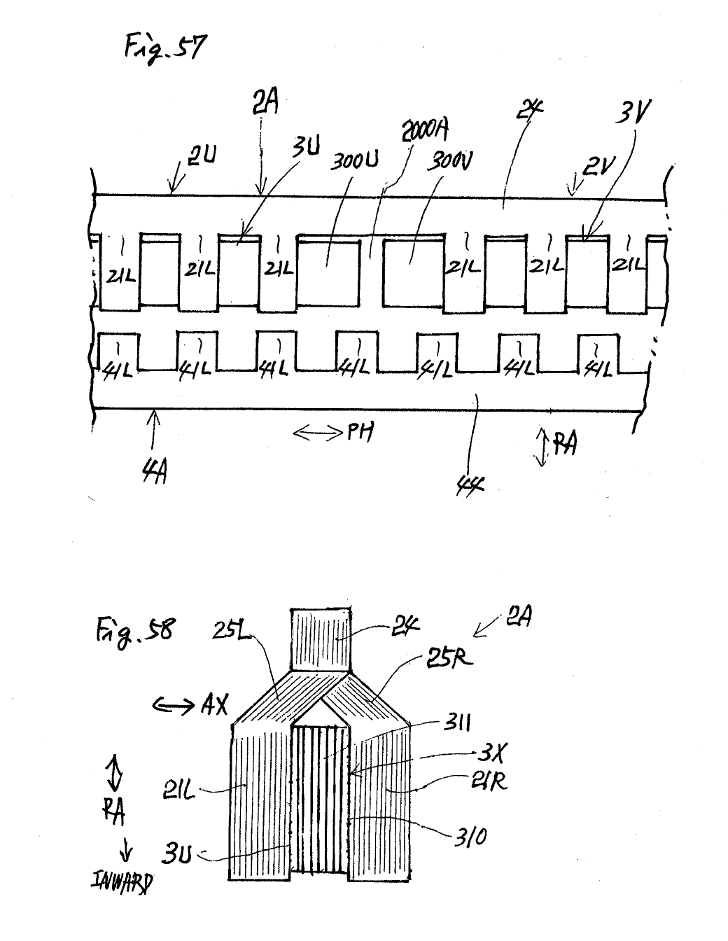

FIG. 55 is an axial cross-section for showing stator cores 2A and 2B and teeth holders 1a, 1b, 1c and 1d. The stator cores 2A and 2B and teeth holders 1a, 1b, 1c and 1d are separated to each other to the axial direction (AX). The teeth holders 1a, 1b, 1c and 1d are non-ferromagnetic members for holding diagonal portions 25L and 25R and teeth 21L and 21R. FIG. 56 is a partial side view showing stator core 2A. Teeth holders 1a, 1b, 1c and 1d are made from aluminum. Each of teeth-holders 1a-1d has a ring portion (a longitudinal portion) 10a and salient 10T projecting inward from the ring portion 10a. Each salient 10T of teeth holders 1a and 1c projects into a space between each two left teeth 21L and 21L, which are adjacent to each other in the circumferential direction PH. Each salient 10T of teeth holders 1b and 1d projects into a space between each two right teeth 21R and 21R, which are adjacent to each other in the circumferential direction PH. A number of salient 10T of each of teeth-holders 1a-1d is equal to a number of either left teeth 21L of stator core 2A. An inner diagonal surface 10d of the ring portion 10a come into contact with outer diagonal surfaces 25a of the diagonal portions 25L and 25R. According to FIG. 55, each circumferential side surface of stator teeth 21L and 21R has each fitting portion consisting of each concave portion 29A extending to axial direction AX.

According to FIG. 55, each circumferential side surface of salient 10T of teeth holders 1a-1d has each fitting portion consisting of each convex portion 19 extending to axial direction AX. Each of the convex portions 19 projecting to the circumferential direction PH is fitted into each of the concave portions 29A. In other words, each convex portion 19 and each concave portion 29A are joined to each other. As shown in FIG. 56, the fitting portions positioned at one side of teeth 21L and 21R in the circumferential direction consist of concave portions 29A, and the the fitting portions positioned at the other side of teeth 21L and 21R in the circumferential direction consist of convex portions 29B. Accordingly, the fitting portions of each teeth holders 1a-1d consist of the convex portions 19 fitting to the concave portions 29A of teeth 21L and 21R and the concave portions fitting to the convex portions 29B of teeth 21L and 21R. After all, the fitting portions of teeth holders 1a-1d and teeth 21L and 21R fitted to each other prohibit extension and shortening of teeth 21L and 21R in the radial direction RA. Vibrations of stator teeth 21L and 21R are restrained because salient 10T extending from ring portion 10a of teeth-holders 1a-1d supports stator teeth 21L and 21R.

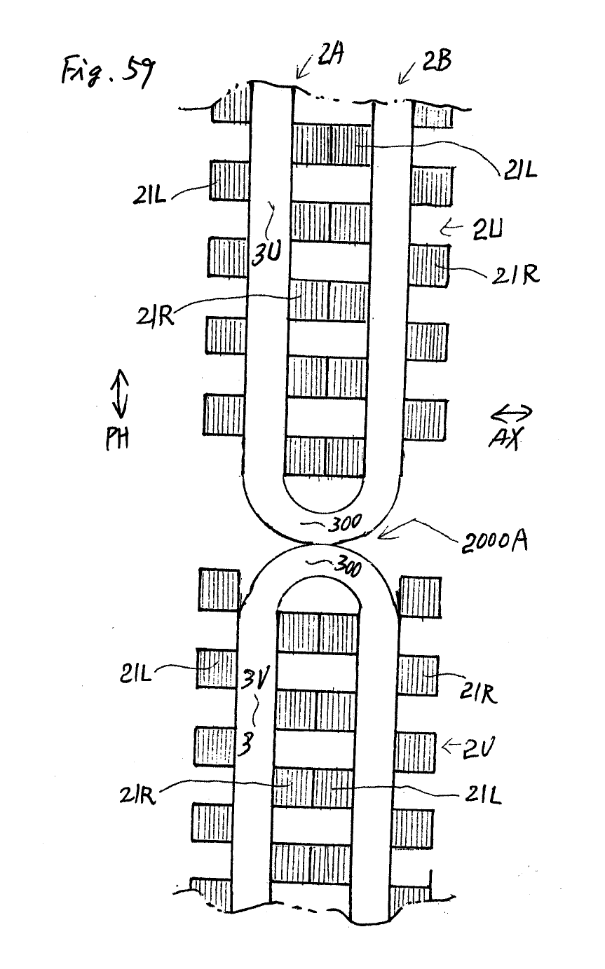

FIG. 57 is a partial development of showing side surfaces of stator core 2A and rotor core 4A near end portions of U-phase winding 3U and V-phase winding 3V, which are adjacent to each other in the circumferential direction PH. Each of stator cores 2A and 2B has wide end-slots 2000A by means of abbreviating stator teeth 21L and 21R. A coil-end portion 300U of U-phase winding 3U and a coil-end portion 300V of V-phase winding 3V are accommodated in the end-slots 2000A as shown in FIG. 57.

FIG. 58 is an axial cross-section showing stator core 2A with U-phase winding 3U. Arc-shaped or ring-shaped winding 3U made of a copper tape 310 covered by an insulation layer is wound helically and accommodated in a ring-shaped slot of stator core 2A. Both of end portions of copper tape 310 as the thin copper plates extends outward after the bending. Copper tape 310 laminated helically achieves the high packing density, the excellent radiation capability and the low skin effect. Moreover, copper tape 310 wound helically can be accommodated easily in a ring-shaped slot of stator core 2A because an diameter of helical copper tape 310 is reduced by means of increasing a turn number of copper tape 310. After all, the stator winding 3U is capable of having a high ratio of the current density and a low copper loss in comparison with a conventional round-shaped conductor line. It means to realize a compact machine.

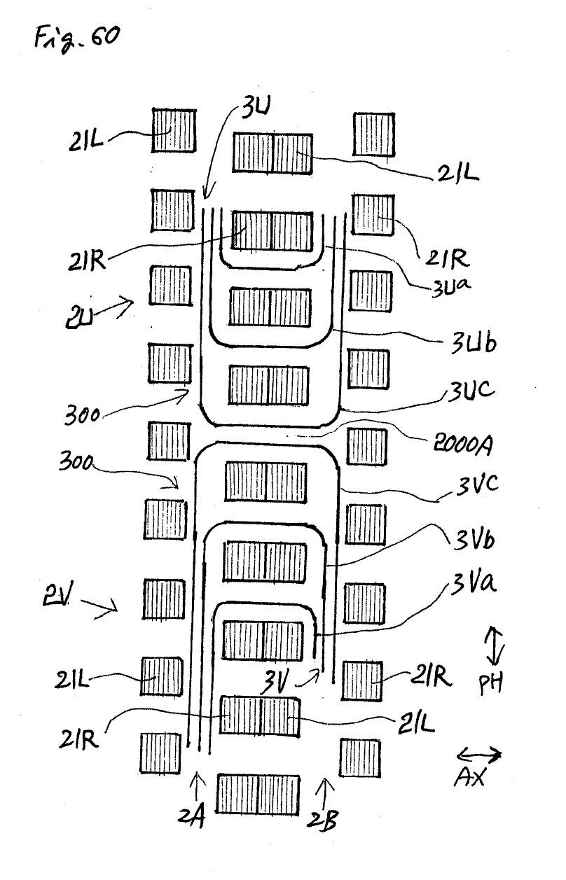

FIG. 59 is a circumferential development of stator cores 2A and 2B with two windings 3U and 3V shown in FIG. 57. FIG. 60 is an arranged circumferential development of two windings 3U and 3V. The coil end 300 of U-phase winding 3U has an inner portion 3Ua, a middle portion 3Ub and an outer portion 3Uc. The coil end 300 of V-phase winding 3U has an inner portion 3Va, a middle portion 3Vb and an outer portion 3Vc. The divided three portions of coil end 300 are wound through different spaces between adjacent two teeth 21L and 21R respectively as shown in FIG. 60. Therefore, end-slots 2000A are shortened.

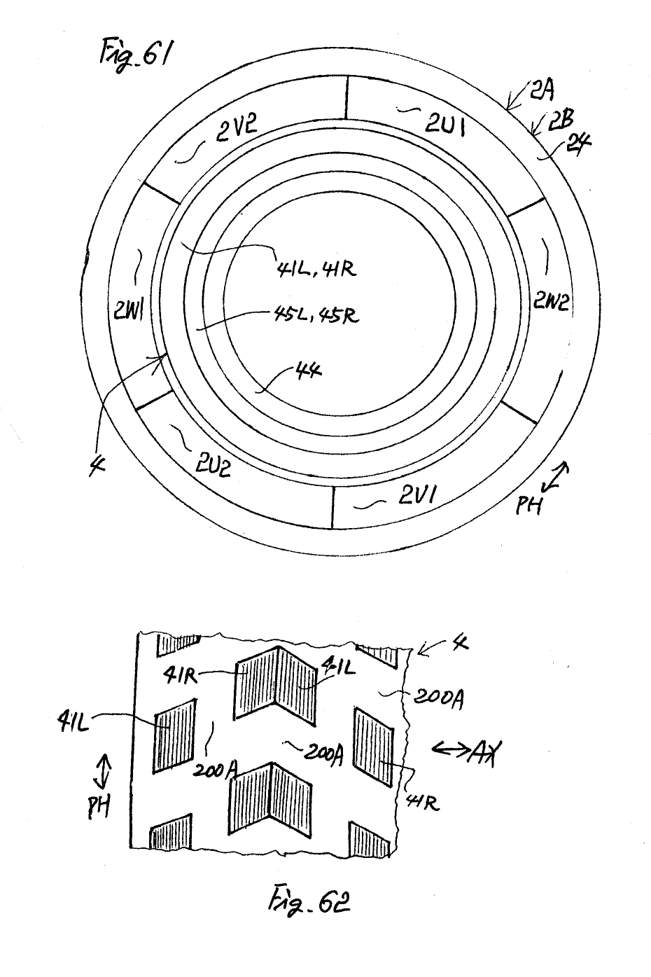

Another arrangement of the stator cores is shown in FIG. 61. FIG. 61 is a schematic side view of a dual-three-phase TFIMs with the circumferential tandem structure. Stator cores 2A and 2B with the circumferential tandem structure have six stator cores 2U1, 2W2, 2V1, 2U2, 2W1 and 2V2 arranged to the circumferential direction in turn. Each of six phase windings 3U1-3W2 are wound on each of six stator cores 2U1, 2W2, 2V1, 2U2, 2W1 and 2V2 respectively. Therefore, the dual-three-phase TFIMs can be driven by a nine-switch shown in a PCT patent application applied by an inventor. FIG. 62 is a circumferential development showing skewed rotor teeth 41L and 41R.

Additional Explanation

Other aspects of the invention are explained. A known TFM has a single-phase winding wound in a ring-shape slot or a arc-shaped slot of a stator core. The stator core has left teeth, right teeth and a yoke portion. The yoke portion connects the left teeth to the right teeth magnetically. The single-phase winding extends in a space between the left teeth and the right teeth toward a moving direction (a longitudinal direction) of a moving core. The difference between the CTFM of the present invention and the conventional TFM is on the addition of diagonal portions (25L, 25R) extending diagonally. The diagonal portions (25L, 25R) realizes the transverse flux machine having an axially-stacked core or a helical-laminated core. The features explained as below can be employed by a conventional TFM.

FIG. 10 shows to employ the reluctance mode in order to generating a starting torque of the transverse induction machine (TFIM). This idea can be employed by the other TFIMs having known core structure. FIGS. 11-13 show two motor-generator sets consisting of the TFIM each. A relay shown in FIG. 11 connects the two TFIMs in a predetermined condition after supplying a common three-phase voltage to two TFIMs in order to reduce the sparking of the relay. The frequency of the common three-phase voltage is controlled in a range between two synchronous frequencies of the two TFIMs. This idea can be employed by the other TFIMs having known core structure.

FIGS. 14-27 show three TFWRMs having a rotor circuit including three secondary windings, a rectifier and three field windings. The secondary windings and the field windings are accommodated in a ring-shaped slots of the rotor core. Preferably, three of the secondary windings with the star-connection supply the field current via the three-phase full-bridge diode rectifier to the three field windings connected in series. Furthermore, the primary field windings wound on the stator cores are disclosed. This idea can be employed by the other TFIMs having known core structure. The primary field windings is desirable for the transverse flux generator such as an alternator or a wind turbine generator.

FIGS. 31-32 show the sequential magnetization process for reducing the circumferential magnetic flux passages. FIGS. 48-51 show the TFPMSRM capable of generating both of the switched reluctance torque and the magnet torque simultaneously without increasing the power loss. This idea can be employed by the other TFIMs having known core structure.

1. A transverse flux machine apparatus including at least one single-phase transverse flux machine (TFM) having a single-phase winding (3U1-3W2, 3U-3W) wound in a space extending between left teeth (21L, 211-213) and right teeth (21R, 212-214) of a stator core (2U1-2W2, 2U-2W) facing a moving core (4U1-4W2, 4U-4W, 600) capable of moving to a moving direction (PH);
wherein the core (2U1-2W2, 2U-2W, 4U1-4W2, 4U-4W) has a yoke portion (24, 44) extending to the moving direction (PH) and diagonal portions (25L, 45L, 25R, 45R) extending diagonally;
the diagonal portions (25L, 45L, 25R, 45R) connect the teeth (21L, 41L, 21R, 41R, 211-214) to the yoke portion (24, 44) magnetically; and
the yoke portion (24, 44), the diagonal portions (25L, 45L, 25R, 45R) and the teeth (21L, 41L, 21R, 41R, 211-214) have iron plates laminated essentially.

2. The transverse flux machine apparatus (TFMA) according to claim 2, wherein the core (2U1-2W2, 2U-2W, 4U1-4W2, 4U-4W) has a first bent portion and a second bent portion;
the first bent portion is formed between the yoke portion (24, 44) and the diagonal portions (25L, 45L, 25R, 45R); and
the second bent portion is formed between the the diagonal portions (25L, 45L, 25R, 45R) and the teeth (21L, 41L, 21R, 41R, 211-214).

3. The transverse flux machine apparatus (TFMA) according to claim 2, wherein the diagonal portions (25L, 25R, 45L, 45R) extend straightly.

4. The transverse flux machine apparatus (TFMA) according to claim 1, wherein the diagonal portions (25L, 45L, 25R, 45R) include left diagonal portions (25L, 45L) extending diagonally to one direction and right diagonal portions (25R, 45R) extending diagonally to another direction;
each of the left diagonal portions (25L, 45L) connects each of the left teeth (21L, 41L) to the yoke portion (24, 44);
each of the right diagonal portions (25L, 45R) connects each of the right teeth (21R, 41R) to the yoke portion (24, 44); and
each of the left teeth (21L, 41L) and each of the right teeth (21R, 41R) are arranged alternately in the moving direction (PH).

5. The transverse flux machine apparatus (TFMA) according to claim 1, wherein the core (2U, 2V, 2W) has a left core (2L) and a right core (2R);
the left core (2L) has the left teeth (21L, 211), the left diagonal portions (25L), left yoke portions (24L) and one longitudinal portion (27) extending to the moving direction (PH);
the right core (2R) has the right teeth (21R, 214), the right diagonal portions (25R), right yoke portions (24R) and another longitudinal portion (27) extending to the moving direction (PH);
the one longitudinal portion (27) connects the left teeth (21L, 211) to the left yoke portions (24L);
the another longitudinal portion (27) connects the right teeth (21R, 214) to the right yoke portions (24R); and
the left yoke portions (24L) and the right yoke portions (24R) arranged alternately in the moving direction (PH) constitute the yoke portion (24).

6. The transverse flux machine apparatus (TFMA) according to claim 5, wherein the left core (2L) further has lower-left diagonal portions (250L) connecting the left teeth (21L) and the longitudinal portions (27); and
the right core (2R) further has lower-right diagonal portions (250R) connecting the right teeth (21R) and the longitudinal portions (27).

7. The transverse flux machine apparatus (TFMA) according to claim 5, wherein the core (2U, 2V, 2W) further have at least one center core (2C1, 2C2) disposed between the left core (2L) and the right core (2R);
each of the single-phase windings (3U, 3V, 3W) is disposed in each space between each two cores (2L, 2C1, 2C2, 2R);
the center core (2C1, 2C2) has the left teeth (21L), the left diagonal portions (25L), the left yoke portions (24L), the right teeth (21L), the right diagonal portions (25R), the right yoke portions (24R) and the longitudinal portion (27); and
the longitudinal portion (27) connects the left teeth (21L) and the right teeth (21R) to the left yoke portions (24L) and the right yoke portions (24R).

8. The transverse flux machine apparatus (TFMA) according to claim 7, wherein the center core (2C1, 2C2) further has lower-left diagonal portions (250L) and lower-right diagonal portions (250R);
the lower-left diagonal portions (250L) connects the left teeth (21L) to the longitudinal portion (27); and
the lower-right diagonal portions (250R) connect the right teeth (21R) to the longitudinal portion (27).

9. The transverse flux machine apparatus (TFMA) according to claim 1, wherein the transverse flux machine apparatus (TFMA) has a teeth-holder (1a-1d) for holding at least one of the diagonal portions (25L, 25R, 45L, 45R) and the teeth (21L, 21R, 41L, 41R);
the teeth-holder (1a-1d) made from non-magnetic metal material has a longitudinal portion (10a) and a plurality of silent (10T);
the longitudinal portion (10a) extending to the moving direction (PH) comes into contact with at least one of the yoke portion (24, 44) and the diagonal portions (25L, 25R, 45L, 45R);
each of the salient (10T) projects from the longitudinal portion (10a) into each space between two diagonal portions (25L, 25R, 45L, 45R) being adjacent to each other in the moving direction (PH);
each of the salient (10T) has a fitting portion (19) consisting of at least one of a convex portion and a concave portion; and
the fitting portion (19) is fitted to a fitting portion (29A, 29B) formed on at least one of the diagonal portions (25L, 25R, 45L, 45R) and the teeth (21L, 21R, 41L, 41R) in order to protect extension and shortening of a length of air gap between the stator core (2U1-2W2, 2U-2W) and the moving core (4U1-4W2, 4U-4W).

10. The transverse flux machine apparatus (TFMA) according to claim 1, wherein the yoke portion (24, 44) of the stator core (2U1-2W2, 2U-2W) extends to a circumferential direction of the stator core (2U1-2W2, 2U-2W);
the teeth (21L, 21R, 41L, 41R) of the stator core (2U1-2W2, 2U-2W) extend inward to a radial direction of the stator core (2U1-2W2, 2U-2W); and
the single-phase winding (3U1-3W2, 3U-3W) wound helically is formed with at least one copper plate laminated to an axial direction of the stator core (2U1-2W2, 2U-2W) and extending to the circumferential direction.

11. The transverse flux machine apparatus (TFMA) according to claim 1, wherein the single-phase transverse flux machine (TFM) consists of a transverse flux switched reluctance machine (TFSRM) having a permanent magnet layer (6) disposed in a space between the teeth (41L, 41R) of the moving core (4U1-4W2, 4U-4W);
the magnet layer (6) has N-pole areas (6N) and S-pole areas (6S);
the N-pole areas (6N) are disposed between the left teeth (41L, 41L); and
the S-pole areas (6S) are disposed between the right teeth (41R, 41R).

12. The transverse flux machine apparatus (TFMA) according to claim 1, wherein the single-phase transverse flux machine (TFM) consists of a plurality of transverse flux wound rotor machines (TFWRMs) arranged in tandem;
each of the transverse flux wound rotor machines (TFWRMs) has a ring-shaped field winding (6U, 6V, 6W) and a ring-shaped secondary winding (60U, 60V, 60W) wound in the ring-shaped space of the moving core (4U-4W); and
the transverse flux machine apparatus (TFMA) further has a rectifier (600A) for rectifying secondary voltages induced across the secondary windings (60U, 60V, 60W) and for supplying a field current to the field windings (6U, 6V, 6W) connected in series.

13. The transverse flux machine apparatus (TFMA) according to claim 12, wherein the rectifier (600A) consists of a three-phase diode rectifier connecting three of the secondary windings (60U, 60V, 60W) to the field windings (6U, 6V, 6W).

14. The transverse flux machine apparatus (TFMA) according to claim 13, wherein each of the transverse flux wound rotor machines (TFWRMs) further has a ring-shaped primary field winding (30U, 30V, 30W) wound on the stator core (2U, 2V, 2W); and
the primary field windings (30U, 30V, 30W) are connected in series.

15. The transverse flux machine apparatus (TFMA) according to claim 1, wherein the single-phase transverse flux machine (TFM) consists of a transverse flux induction machine (TFIM) having a squirrel-cage secondary winding (200, 200A); and
the transverse flux induction machine (TFIM) is started as a transverse flux reluctance machine (TFRM) producing a reluctance torque.
